(19) United States
(12) Patent Application Publication
(10) Pub. No.: US 2013/0056555 A1
(43) Pub. Date: Mar. 7, 2013

(54) ODOR RELEASE SYSTEM, ELECTRONIC DEVICE, ARTICLE, ODOR RELEASE CONTROL METHOD FOR ODOR RELEASE SYSTEM, PROGRAM, COMPUTER-READABLE RECORDING MEDIUM

(71) Applicants: Takayuki Yuhki, Osaka-shi (JP); Toshihiro Ohta, Osaka-shi (JP); Hiroshi Fuji, Osaka-shi (JP)

(72) Inventors: Takayuki Yuhki, Osaka-shi (JP); Toshihiro Ohta, Osaka-shi (JP); Hiroshi Fuji, Osaka-shi (JP)

(73) Assignee: SHARP KABUSHIKI KAISHA, Osaka-shi, Osaka (JP)

(21) Appl. No.: 13/639,222

(22) PCT Filed: Apr. 5, 2011
(86) PCT No.: PCT/JP11/58594

§ 371 Date: Oct. 4, 2012

(30) Foreign Application Priority Data
Apr. 7, 2010 (JP) 2010-088736

(51) Int. Cl. B05B 15/00

(52) U.S. Cl. 239/289

(57) ABSTRACT

An odor release system includes an odor releasing section (4) which is provided to a housing containing an odor source and releases an odor from the housing to the outside, a moving body detecting section (2) for detecting a moving body that approaches the housing, and a control section (3). The control section (3) includes (i) a moving speed calculating section (31) for calculating a moving speed of the moving body on the basis of a detection signal received from the moving body detecting section (2) and (ii) an odor release control section (32) for causing the odor releasing section (4) to release the odor in a case where the moving speed calculated by the moving speed calculating section (31) is not higher than a preset speed.

### TECHNICAL FIELD

The present invention relates to a technique of releasing an odor to a limited target, specifically to an odor release system, an electronic device, and an article for releasing an odor to a target limited on the basis of a moving speed of a moving body, an odor release control method for the odor release system, a program, and a computer-readable recording medium.

### BACKGROUND ART

Conventionally, products that sense a human body and release an odor have been developed. Among techniques of sensing a person who approaches and releasing an odor, there are known techniques as disclosed in, for example, Patent Literatures 1 through 3.

For example, Patent Literature 1 discloses a technique of (i) detecting, by means of a human sensor, a human body that approaches and (ii) automatically generating fragrance that corresponds to one of a plurality of artificial flowers.

Patent Literature 2 discloses a technique of discharging a fragrance in synchronization with a timing of breathing in. Patent Literature 3 discloses a technique of detecting a voice from a speaker or the like and generating a fragrance.

### CITATION LIST

### Patent Literature

Patent Literature 1

Japanese Patent Application Publication, Tokukaihei, No. 6-207304 A (Publication Date: Jul. 26, 1994)

Patent Literature 2

Japanese Patent Application Publication, Tokukai, No. 2009-82273 A (Publication Date: Apr. 23, 2009)

Patent Literature 3

Japanese Patent Application Publication, Tokukai, No. 2004-260764 A (Publication Date: Sep. 16, 2004)

### SUMMARY OF INVENTION

### Technical Problem

However, in all of these techniques, an odor is released in response to the sensing of a human body, and it is not possible to release the odor to a particular person.

That is, according to the conventional techniques, a fragrance is generated in whatever situations, if a human body is detected. This may result in a wasteful consumption of odor ingredients.

In addition, in a case where a housing containing a sent source of the odor ingredients needs maintenance and control of an environment (environmental protection) inside the housing by, for example, (i) controlling a temperature and humidity inside the housing and (ii) maintaining a concentration of a gaseous component such as carbon dioxide (CO₂) inside the housing, there is a trade-off between (a) the release of the odor ingredients and (b) the maintenance and control of the environment inside the housing.

As such, (i) releasing an odor all the time or (ii) releasing an odor unconditionally whenever a person approaching is detected also leads to an increased cost of energy for the maintenance of the environment to be protected.

The present invention is accomplished in view of the problem. An object of the present invention is to provide a technique that enables releasing of an odor to a limited target.

### Solution to Problem

In order to attain the object, an odor release system in accordance with the present invention is an odor release system including: (1) an odor release device provided to a housing that contains an odor source, the odor release device releasing an odor from the housing to an outside of the housing; (2) a moving body detecting device for detecting a moving body that approaches the housing; and (3) a control device including (i) a moving speed calculating section for calculating a moving speed of the moving body on the basis of a detection signal received from the moving body detecting device and (ii) an odor release control section for causing the odor release device to release the odor in a case where the moving speed calculated by the moving speed calculating section is not higher than a preset speed.

In order to attain the object, an odor release control method for an odor release system in accordance with the present invention is an odor release control method for an odor release system including: (1) an odor release device provided to a housing that contains an odor source, the odor release device releasing an odor from the housing to an outside of the housing; and (2) a moving body detecting device for detecting a moving body that approaches the housing, said odor release control method comprising the steps of: (i) calculating a moving speed of the moving body on the basis of a detection signal indicative of detection of the moving body approaching the housing; and (ii) causing the odor release device to release the odor in a case where the moving speed calculated in the step (i) is not higher than a preset speed.

According to the configurations above, the moving body approaching the housing containing the odor source is classified into (i) a moving body to which the odor is to be released or (ii) a moving body to which the odor is not to be released, on the basis of whether or not the moving speed of the moving body approaching the housing is not higher than the preset speed. Only when the moving body to which the odor is to be released approaches the housing, the odor is released from the odor release device to the outside.

That is, in a case where, for example, an object to which the odor is to be released is a “person,” (i) a moving body having a low moving speed is considered as a “person who is interested (in the housing containing the odor source)” or a “person who is not in a hurry,” and (ii) a moving body having a high moving speed is considered as a moving body (person) which (who) is not the object to which the odor is to be released, that is, the moving body is considered as, for example, a “person who is not interested” or a “person who is in a hurry.”

Thus, according to the present invention, a target to which the odor is to be released is limited on the basis of the moving speed of the moving body. This makes it possible to prevent wasteful release of an odor ingredient to the moving body which is not the object to which the odor is to be released.

In particular, in a case where the housing containing the odor source of the odor ingredient requires maintenance and control (environmental protection) inside the housing (e.g. control of a temperature and a humidity inside the housing, maintenance of a concentration of a gaseous component such as CO₂), there is a trade-off between (i) the release of the odor ingredient and (ii) the maintenance of an environment inside the housing.

As such, according to the present invention, releasing the odor to a limited target as described above not only provides a direct merit resulting from the odor itself, such as (i) attracting more customers and (ii) encouraging more customers to make a purchase, but also reduces a demerit of releasing the odor. That is, for example, it is possible to achieve various effects such as (i) reducing a cost of the maintenance and control of the environment inside the housing (e.g. maintenance and control of the temperature and the humidity inside the housing), which cost results from releasing the odor or (ii) prevention or suppression of (a) a reduction in supply of the gaseous component inside the housing, which reduction is caused by consumption of the gaseous component at the time of releasing the odor or (b) harm caused by smoke, in which form the odor is released.

Further, in order to attain the object, an odor release system in accordance with the present invention is an odor release system including: (1) an odor release device provided to a housing in which a plant serving as an odor source is contained and cultivated, the odor release device releasing an odor from the housing to an outside of the housing; (2) a concentration measuring device for measuring a concentration of a gas that is necessary for cultivating the plant inside the housing; (3) a moving body detecting device for detecting a moving body that approaches the housing; and (4) a control device including (i) a moving speed calculating section for calculating a moving speed of the moving body on the basis of a detection signal received from the moving body detecting section and (ii) an odor release control section for causing the odor release device to release the odor in a case where (a) a value indicative of the concentration measured by the concentration measuring device is higher than a preset value and (b) the moving speed calculated by the moving speed calculating section is not higher than a preset speed.

In order to attain the object, an odor release control method for an odor release system in accordance with the present invention is an odor release control method for an odor release system including: (1) an odor release device provided to a housing in which a plant serving as an odor source is contained and cultivated, the odor release device releasing an odor from the housing to an outside of the housing; (2) a concentration measuring device for measuring a concentration of a gas that is necessary for cultivating the plant inside the housing; and (3) a moving body detecting device for detecting a moving body that approaches the housing, said odor release control method comprising: (i) calculating a moving speed of the moving body on the basis of a detection signal indicative of detection of the moving body approaching the housing; and (ii) causing the odor release device to release the odor in a case where (a) a value indicative of the concentration of the gas that is necessary for cultivating the plant inside the housing is higher than a preset value and (b) the moving speed calculated in the step (i) is not higher than a preset speed.

Also in these configurations, the moving body approaching the housing containing the odor source is classified into (i) a moving body to which the odor is to be released or (ii) a moving body to which the odor is not to be released, on the basis of whether or not the moving speed of the moving body approaching the housing is not higher than the preset speed. Only in a case where the moving body to which the odor is to be released approaches the housing, the odor is released from the odor release device to the outside.

That is, in a case where, for example, an object to which the odor is to be released is a “person,” (i) a moving body having a low moving speed is considered as a “person who is interested (in the housing containing the odor source)” or a “person who is not in a hurry,” and (ii) a moving body having a high moving speed is considered as a moving body (person) which (who) is not the object to which the odor is to be released, that is, the moving body is considered as, for example, a “person who is not interested (in the housing containing the odor source)” or a “person who is in a hurry.”

Thus, according to the present invention, a target to which the odor is to be released is limited on the basis of the moving speed of the moving body. This makes it possible to prevent wasteful release of an odor ingredient to the moving body which is not the object to which the odor is to be released.

In particular, in a case where the housing containing the odor source of the odor ingredient requires maintenance and control (environmental protection) inside the housing (e.g. control of a temperature and a humidity inside the housing, maintenance of a concentration of a gaseous component such as CO₂), there is a trade-off between (i) the release of the odor ingredient and (ii) the maintenance of an environment inside the housing.

As such, according to the present invention, releasing the odor to a limited target as described above not only provides a direct merit resulting from the odor itself, such as (i) attracting more customers and (ii) encouraging more customers to make a purchase, but also reduces a demerit of releasing the odor. That is, for example, it is possible to achieve various effects such as (i) reducing a cost of the maintenance and control of the environment inside the housing (e.g. maintenance and control of the temperature and the humidity inside the housing), which cost results from releasing the odor or (ii) prevention or suppression of a reduction in supply of the gaseous component inside the housing, which reduction is caused by consumption of the gaseous component at the time of releasing the odor.

Moreover, according to the configurations, the odor is released so as to attract more customers and encourage the customers to make a purchase. In addition, the odor is released only to a person who has a relatively low moving speed and is therefore considered to be interested or not in a hurry. This makes it possible to reduce an amount of supply of the gaseous component (active ingredient for plant cultivation, such as CO₂) which is necessary for the plant cultivation inside the housing, which amount is necessary in order to maintain the concentration of the gaseous component to a fixed level. Further, releasing the odor to a limited target in this manner makes it possible to maintain (i) the temperature and humidity in the housing and (ii) the concentration of the active ingredient for plant cultivation in the housing. Thus, the environment for the cultivation of the plant can be kept in a good condition. In addition, it becomes easier to maintain and control (i) the temperature and humidity in the housing and (ii) the concentration of the active ingredient for the plant cultivation in the housing.

Further, according to the configurations, in terms of comparison between (i) release of the odor and (ii) maintenance of the concentration of the active ingredient for the plant cultivation in the present embodiment, giving priority to the maintenance over the release makes it possible to maintain the concentration of the active ingredient for the plant cultivation at a level higher than the preset threshold. This further facilitates the maintenance and control of (i) the temperature and humidity in the plant cultivation chamber and (ii) the concentration of the active ingredient for the plant cultivation in the plant cultivation chamber.

An electronic device in accordance with the present invention includes an odor release system in accordance with the present invention.

Examples of the electronic device encompass an artificial weather control device.

An article in accordance with the present invention includes an odor release system in accordance with the present invention.

According to these configurations, it is possible to achieve the various effects since the electronic device or the article includes an odor release system in accordance with the present invention.

The artificial weather control device, in particular, is a device having a plant cultivation chamber to which a gaseous component (active ingredient for plant cultivation) required for cultivation of a plant is supplied and in which the plant is cultivated and reared by means of artificial lighting, proper control of temperature and humidity, and the like. The artificial weather control device has a small area for the cultivation, and is therefore more suitably used as a device for demonstration at an exhibition site such as a super market and a shopping mall, rather than a device for a real-scale rearing of a plant.

However, conventional artificial weather control devices are not provided with the odor releasing device as described above, and carry out demonstration that relies on the sense of sight.

In such demonstration, it is possible to attract more customers if a visual effect is combined with a stimulation of the sense of smell by releasing an odor (an aromatic ingredient) of a plant (e.g. strawberries) which emits an aroma and serves as an odor source in the artificial weather control device. However, there is a trade-off between (i) release of the odor which fills inside the artificial weather control device and (ii) maintenance and control of (a) a concentration of the active ingredient for the plant cultivation and (b) a temperature and a humidity.

As such, in a case where the electronic device is the artificial weather control device, since the artificial weather control device is equipped with the odor release system in accordance with the present invention, it is possible to not only attract more customers and encourage more customers to make a purchase by releasing the odor, but also reduce consumption (supply) of the gaseous component (active ingredient for the plant cultivation) required for cultivating the plant inside a main body (serving as a housing) of the artificial weather control device. It also becomes possible to (i) maintain (a) the temperature and the humidity inside the housing and (b) the concentration of the active ingredient for the plant cultivation inside the housing, and (ii) accordingly, keep the environment for the plant cultivation in a good condition. Further, maintenance and control of (i) the temperature and the humidity in the housing and (ii) the concentration of the active ingredient for the plant cultivation in the housing is facilitated.

Note that each step of the odor control methods for the odor release systems can be realized by use of a computer. In this case, it is possible to cause the computer to execute each step of the odor release control methods for the odor release systems in accordance with a program. As such, (i) the program for causing the computer to realize the odor control methods for the odor release systems and (ii) a computer-readable recording medium in which the program is recorded, are also included in the scope of the present invention.

### Advantageous Effects of Invention

Thus, according to the present invention, a target to which an odor is to be released is limited on the basis of a moving speed of a moving body. This makes it possible to prevent wasteful release of the odor to a moving body which is not an object to which the odor is to be released.

As such, it is possible to not only achieve, by releasing the odor, an effect provided by the odor itself, but also achieve various effects such as a reduction in costs resulting from releasing the odor, which costs are, for example, costs of (i) protection of an environment inside the housing (e.g. a temperature and a humidity inside the housing) and (ii) consumption of a gaseous component including an odor ingredient inside the housing.

### BRIEF DESCRIPTION OF DRAWINGS

FIG. 1

FIG. 1 is a block diagram illustrating a configuration of an odor release system in accordance with Embodiment 1 of the present invention.

FIG. 2

FIG. 2 is a schematic view illustrating an outer appearance of an artificial weather control device in accordance with Embodiment 1 of the present invention.

FIG. 3

FIG. 3 is a flow chart showing a process of odor release carried out by the odor release system illustrated in FIG. 1.

FIG. 4

FIG. 4 is a view illustrating how a moving body detecting section illustrated in FIG. 1 detects a moving body.

FIG. 5

FIG. 5 is a block diagram illustrating a configuration of an odor release system in accordance with Embodiment 2 of the present invention.

FIG. 6

FIG. 6 is a schematic view illustrating an outer appearance of an artificial weather control device in accordance with Embodiment 3 of the present invention.

FIG. 7

FIG. 7 is a view illustrating how a moving body detecting section illustrated in FIG. 6 detects a moving body.

FIG. 8

FIG. 8 is a schematic view illustrating an outer appearance of a shop to which an odor release system in accordance with Embodiment 4 of the present invention is attached.

FIG. 9

FIG. 9 is a block diagram illustrating a configuration of the odor release system in accordance with Embodiment 4 of the present invention.

FIG. 10

FIG. 10 is a flow chart showing a flow of a process of odor release carried out by the odor release system illustrated in FIG. 9.

FIG. 11

FIG. 11 is a schematic view illustrating an outer appearance of an artificial weather control device in accordance with Embodiment 5 of the present invention.

FIG. 12

FIG. 12 is a block diagram illustrating a configuration of an odor release system in accordance with Embodiment 5 of the present invention.

FIG. 13

FIG. 13 is a flow chart showing a flow of a process of odor release carried out by the odor release system illustrated in FIG. 12.

### DESCRIPTION OF EMBODIMENTS

The following description will discuss in detail embodiments of the present invention.

### Embodiment 1

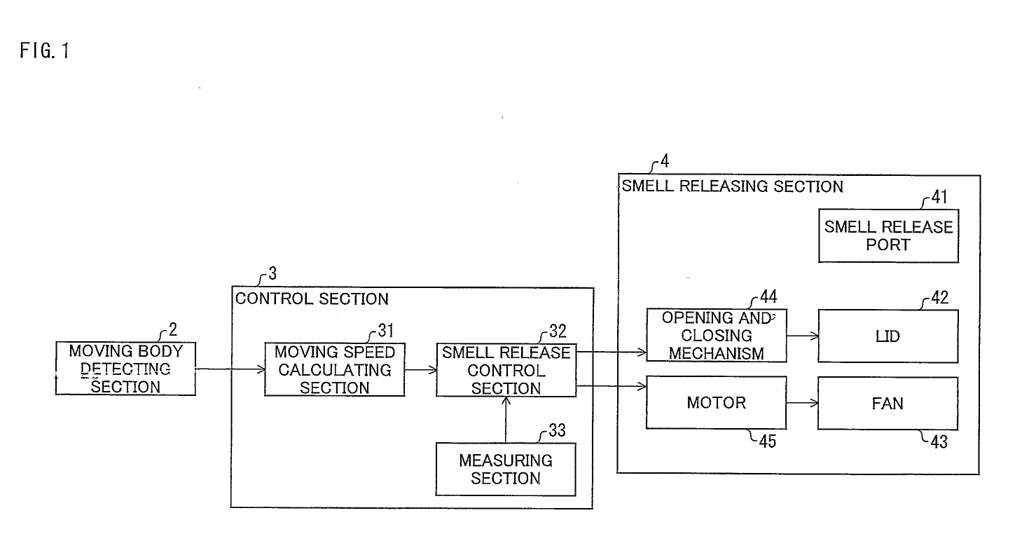

The following description will discuss, with reference to FIGS. 1 through 4, an embodiment of the present invention.

In the present embodiment, an artificial weather control device is discussed as an example of an electronic device having an odor release system in accordance with the present invention.

<General Configuration of Artificial Weather Control Device>

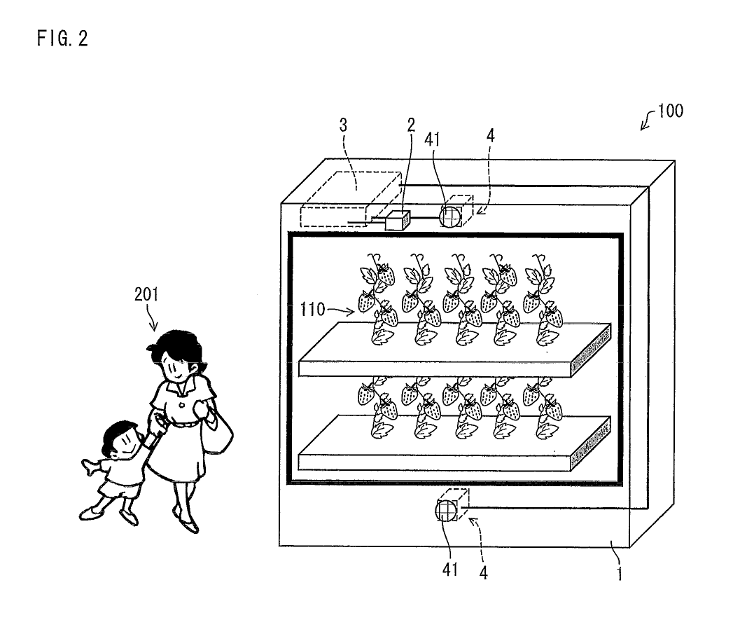

FIG. 1 is a block diagram illustrating a configuration of an odor release system in accordance with the present embodiment. FIG. 2 is a view schematically illustrating an outer appearance of an artificial weather control device in accordance with the present embodiment.

As illustrated in FIG. 1, the odor release system in accordance with the present embodiment includes a moving body detecting section 2 which serves as a moving body detecting device, a control section 3 which serves as a control device, an odor releasing section 4 which serves as an odor detecting device. Configurations of the respective devices (sections) will be described later.

As illustrated in FIG. 2, the artificial weather control device 100 in accordance with the present embodiment is arranged such that the devices (sections) of the odor release system in accordance with the present embodiment are mounted to a main body 1 (housing) of the artificial weather control device, which is a main body of the electronic device in accordance with the present embodiment.

As illustrated in FIG. 2, the artificial weather control device 100 includes the main body 1 of the artificial weather control device, the moving body detecting section 2, the control section 3, and the odor releasing section 4.

The following description will describe a configuration of each section (device) of the artificial weather control device 100.

<Main Body 1 of Artificial Weather Control Device>

The main body 1 of the artificial weather control device is a device in which a plant that serves as an odor source 110 is contained and cultivated. Various types of conventionally known artificial weather control devices can be used as the main body 1 of the artificial weather control device. That is, the artificial weather control device 100 is arranged such that the moving body detecting section 2, the control section 3, and the odor releasing section 4 are mounted, as described above, to a general artificial weather control device that constitutes the main body 1 of the artificial weather control device.

An artificial weather control device is a device which (i) includes a plant cultivation chamber in which a plant is contained and cultivated, an air conditioning device, a lighting device, a feeding device that supplies, into the plant cultivation chamber, oxygen (O₂), carbon dioxide (CO₂), water vapor, and the like which are necessary for cultivation of the plant and (ii) replicates all sorts of complex environments by means of artificial lighting, proper temperature and humidity controls, and the like so as to allow plants to be cultivated (reared) in the complex environments.

The main body 1 of the artificial weather control device is provided with the conditioning device, the lighting device, the feeding device, and the like (none of which is shown) which are necessary for protecting an environment for cultivating a plant.

The main body 1 of the artificial weather control device is also provided with (i) an observation window for observation of the plant that serves as the odor source 110 and (ii) a door (not shown) for, for example, planting, harvesting, and maintaining the plant.

Note that the artificial weather control device itself, which constitutes the main body 1 of the artificial weather control device, has a similar configuration as those of conventional artificial weather control devices. As such, a detailed description of the configuration intrinsic to the main body 1 of the artificial weather control device is omitted.

In the present embodiment, the plant which is contained in the main body 1 of the artificial weather control device and serves as the odor source 110 is exemplified as strawberries, as illustrated in FIG. 2. Note, however, that the odor source 110 is not limited to any specific one, as long as its odor can be perceived by the sense of smell.

<Configuration of Moving Body Detecting Section 2>

The moving body detecting section 2 is constituted by a sensor or the like and faces the outside of the main body 1 of the artificial weather control device. The moving body detecting section 2 detects a moving body 201 (object that moves) that approaches the housing (in the present embodiment, the main body 1 of the artificial weather control device) containing the odor source 110.

Since, the moving body detecting section 2 detects the moving body 201 that approaches the housing containing the odor source 110 as described above, it is preferable that the moving body detecting section 2 be (i) included in the housing containing the odor source 110 or (ii) provided in the vicinity of the housing. FIG. 2 shows an example in which the moving body detecting section 2 i s provided in the vicinity of an odor release port 41 of the main body 1 of the artificial weather control device. Note, however, that the present embodiment is not limited to this.

The sensor used as the moving body detecting section 2 can be, for example, a Doppler sensor (Doppler radar). The Doppler sensor is a sensor that utilizes the Doppler effect, in which a frequency of a reflected wave changes in accordance with a speed of a moving body. The Doppler sensor includes an oscillator that produces oscillating microwaves, a transmission antenna for transmitting the microwaves, a reception antenna that receives microwaves reflected from a moving body, a mixer that mixes the microwaves thus received and outputs a mixed signal thus obtained, and the like. The Doppler sensor detects the moving body (detects a movement of the moving body) by detecting a difference between a frequency of the microwaves transmitted by the transmission antenna and a frequency of the microwaves reflected from the moving body.

Note that the detection (observation) of the movement of the moving body 201 can be carried out one-dimensionally or two-dimensionally, depending on an environment in which the artificial weather control device 100 is provided. For example, it is possible to understand a two-dimensional movement of the moving body 201 by observing the moving body 201 by use of a plurality of Doppler sensors (Doppler radars) at the same time (dual Doppler radar observation) and analyzing a result of the observation.

In the present embodiment, the Doppler sensor is used as the moving body detecting section 2 as described above. On the basis of a moving speed of the moving body 201 which moving speed is detected by means of the Doppler sensor, a person (pedestrian) who approaches the main body 1 of the artificial weather control device is detected to be the moving body 201 which approaches the housing containing the odor source 110.

<Configuration of Odor Releasing Section 4>

The following description will discuss, before discussing the control section 3, a configuration of the odor releasing section 4 with reference to FIGS. 1 and 2.

The odor releasing section 4 is included in the housing (in the present embodiment, the main body 1 of the artificial weather control device) containing the odor source 110, and releases an odor from the housing to the outside.

As illustrated in FIG. 1, the odor releasing section 4 includes an odor release port 41, a lid 42 (opening and closing lid), a fan 43 (air blower), an opening and closing mechanism 44, and a motor 45.

The odor release port 41 is an opening (i) which is provided on the housing, which contains the odor source 110, so as to face the outside and (ii) through which an odor produced from the odor source 110 is released toward the moving body 201 that approaches the housing.

The odor release port 41 is provided with (i) the lid 42 for opening and closing the odor release port 41 and (ii) the fan 43 for sending air from the odor release port 41 to the outside of the housing.

The lid 42 is connected with the opening and closing mechanism 44, by which the lid 42 is driven so as to open and close. The fan 43 is connected with the motor 45, by which the fan 43 is driven so as to rotate. Driving of the opening and closing mechanism 44 and driving of the motor 45 are controlled by the control section 3.

FIG. 2 shows an example in which the odor release port 41 is provided in the vicinities of the observation window of the main body 1 of the artificial weather control device, specifically at two places near the center of the observation window, one of the two places being above the observation window, the other of the two places being below the observation window. Note, however, that the number, size, and arrangement of the odor release port 41 are not limited to specific ones and can be set appropriately in consideration of the size of the main body 1 (housing) of the artificial weather control device, costs, and the like.

<Configuration of Control Section 3>

The control section 3 calculates a moving speed of the moving body 201 on the basis of a detection signal received from the moving body detecting section 2, and uses the moving speed, thus calculated, as a controllable factor so as to control release of an odor from the odor releasing section 4.

The calculation of the moving speed of the moving body 201 by the control section 3 and the release of the odor by the odor releasing section 4 are triggered by the detection signal received from the moving body detecting section 2.

As illustrated in FIG. 1, the control section 3 includes a moving speed calculating section 31 (moving speed calculating means), an odor release control section 32 (odor releasing means), and a measuring section 33 (measuring means).

The moving speed calculating section 31 calculates the moving speed of the moving body 201 on the basis of the detection signal received from the moving body detecting section 2.

In a case where the Doppler sensor (Doppler radar) is used as the moving body detecting section 2 as described above, the Doppler effect makes a wavelength of a wave, which is reflected from the moving body 201 to be observed (detected), longer as the moving body 201 moves away from the Doppler sensor and shorter as the moving body 201 moves closer to the Doppler sensor. In the present embodiment, it is possible to calculate the moving speed of the moving body 201 by measuring such a change in the wavelength by means of the Doppler sensor.

The odor release control section 32 controls the driving of the opening and closing mechanism 44 and the driving of the motor 45 in the odor releasing section 4, so that the release of the odor from the odor releasing section 4 is controlled.

The odor release control section 32 limits the moving body 201 to which the odor is to be released, on the basis of a comparison between (i) the moving speed of the moving body 201 that approaches the housing containing the odor source 110 and (ii) a predetermined moving speed threshold. Only in a case where the moving body 201 (person to whom the odor is to be released) to which the odor is to be released approaches the housing, the odor release control section 32 causes the odor releasing section 4 to release the odor.

The measuring section 33 measures how much time has elapsed since the release of the odor from the odor releasing section 4 w as started. On the basis of a result measured by the measuring section 33, the odor release control section 32 causes the release of the odor from the odor releasing section 4 to stop.

<Outline of Control by Odor Release Control Section 32>

Next, the following description gives an outline of control carried out by the odor release control section 32.

As described above, the odor release control section 32 releases the odor from the odor releasing section 4 only in a case where the moving body 201 (person to whom the odor is to be released) to which the odor is to be released approaches the housing. Note that the moving body 201 (person to whom the odor is to be released) to which the odor is to be released is a moving body 201 having a moving speed not higher than a preset speed (moving speed threshold).

The odor release control section 32 causes the lid 42 to open and the fan 43 to be driven only in a case where the moving speed of the moving body 201 calculated by the moving speed calculating section 31 is not higher than the preset speed. This causes the odor to be released from the odor releasing section 4 only in a case where the moving speed of the moving body 201 calculated by the moving speed calculating section 31 is not higher than the preset speed.

In the present embodiment, the moving speed threshold is set in accordance with walking speeds of pedestrians. In the present embodiment, the person to whom the odor is to be released is determined on the basis of walking speeds of observers (pedestrians) in an environment, such as a super market, a shopping mall, and an exhibition hall, which environment is a site of demonstration of the artificial weather control device 100 and in which environment the artificial weather control device 100 is installed.

That is, the artificial weather control device used as the main body 1 of the artificial weather control device is, as described above, a device which (i) has a plant cultivation chamber, to which O₂, CO₂, water vapor, and the like required for cultivation of a plant are supplied and in which the plant is cultivated and reared by means of artificial lighting, proper control of temperature and humidity, and the like and (ii) has a small area for the cultivation. As such, the artificial weather control device is more suitably used as a device for demonstration at an exhibition site such as a super market and a shopping mall, rather than a device for a real-scale rearing of a plant.

However, conventional artificial weather control devices are not provided with the odor releasing section 4 as described above, and carry out demonstration that relies on the sense of sight.

In such demonstration, it is possible to attract more customers if a visual effect is combined with a stimulation of the sense of smell by releasing (spraying and diffusing) a fragrance, i.e., an aromatic ingredient. In a case where a fruit, a typical example of which is strawberries, is cultivated as a plant as illustrated in FIG. 2, a sweet fragrance (odor) of the strawberries appeals to the sense of smell, so that an effect of the demonstration is enhanced.

However, there is a trade-off between (i) the release of the fragrance (odor) which fills the plant cultivation chamber of the artificial weather control device and (ii) maintenance and control of (a) a concentration of a gaseous component (active ingredient for plant cultivation), such as CO₂, which is necessary for cultivation of a plant and (b) temperature and humidity.

As such, it is unfavorable, in terms of maintenance and control of the environment for the cultivation of the plant, to (i) keep releasing, as the odor, an odor of the plant in the plant cultivation chamber all the time or (ii) release, as the odor, the odor of the plant whenever a person comes close to the artificial weather control device.

In addition, in a case where the odor of the plant in the plant cultivation chamber is released every time a person comes close to the artificial weather control device, the odor is released even to a person who is not interested in the demonstration and to a person who is in a hurry. This results in wasteful consumption of (i) an odor ingredient (aromatic ingredient) released from the plant cultivation chamber and (ii) an active ingredient for the plant cultivation. In addition, consumption of the active ingredient for the plant cultivation and a cost of energy for the control of temperature and humidity are increased.

As such, in the present embodiment, the moving speed of the moving body 201 that approaches the artificial weather control device 100 is detected as described above so as to limit a person to whom the odor (odor of the odor source 110) is to be released. This allows releasing the odor from the odor release port 41 only in a case where the person to whom the odor is to be released approaches the artificial weather control device 100, instead of releasing the odor unconditionally whenever a person, which is the moving body 201, approaches the artificial weather control device 100.

In the present embodiment, the moving body 201 that approaches the artificial weather control device 100 is classified, by the moving speed of the moving body 201, into a first group (a person who is interested and a person who is not in a hurry) or a second group (a moving body (person) who does not belong to the first group; for example, a person who is not interested and a person who is in a hurry), on the assumption that the moving body 201 belongs to either one of the first group and the second group. In the present embodiment, a “person who is interested” denotes, for example, a “person who is interested in the housing containing the odor source 110,” more specifically, a “person who is interested in the demonstration by the artificial weather control device 100.” Note, however, that the “person who is interested” is not limited to this.

The classification is carried out by comparing (i) the moving speed of the moving body 201 that approaches the artificial weather control device 100 with (ii) the moving speed threshold that has been preset as described above.

Note that the moving speed threshold is set in accordance with (i) a purpose for which an electronic device in accordance with the present invention or an article in accordance with the present invention, each of which is equipped with the odor release system, is used or (ii) the moving speed of a moving body 201 to which an odor is to be released in an environment in which the electronic device or the article is installed.

In the present embodiment, the moving speed threshold is set in accordance with, for example, walking speeds of observers (pedestrians) at a demonstration site of the artificial weather control device 100.

That is, the moving speed threshold is not limited to any specific one, and can be set appropriately in accordance with, for example, an environment in which the artificial weather control device 100 is installed (e.g., (i) whether the artificial weather control device 100 is installed in an indoor passage, in a room, or outside a building or (ii) whether or not a passage in which the artificial weather control device 100 is installed is one-way) and the like.

In the present embodiment, a moving body 201 having a moving speed not higher than the threshold is classified into the first group, and a moving body 201 having a moving speed higher than the threshold is classified into the second group.

The moving body 201 (person) that belongs to the first group is determined to be a person to whom the odor is to be released. In a case where the moving speed of the moving body 201 that approaches the artificial weather control device 100 is not higher than the threshold, a sweet fragrance (odor) of strawberries is released from the odor release port 41 as the odor of the odor source 110 in the plant cultivation chamber in the main body 1 of the artificial weather control device. In a case where the odor release control section 32 determines that the moving body 201 belongs to the second group (i.e., the moving body 201 is not a person to whom the odor is to be released), no odor is released from the odor release port 41.

According to this, the odor of the odor source 110 is released to a person who belongs to the first group, so that more customers are attracted and the customers are encouraged to buy a product (in the present embodiment, the odor source 110 (strawberries) itself) related to the odor thus released, which product is a product to be sold. To the moving body 201 (person) that belongs to the second group, on the other hand, no odor is released from the odor release port 41. This reduces a loss of an active ingredient (e.g., CO₂) for the plant cultivation in the plant cultivation chamber, and maintains the temperature and humidity inside the plant cultivation chamber. Accordingly, the environment inside the chamber is protected.

Note that (i) a person who approaches the artificial weather control device 100 with an intention of buying the product to be sold through the demonstration in which the artificial weather control device 100 is used or (ii) a person who approaches the artificial weather control device 100 with great interest in the demonstration in which the artificial weather control device 100 is used may have a high moving speed.

However, such a person already has an objective to buy the product to be sold. As such, the person moves toward the artificial weather control device 100 irrespective of whether or not the odor is released, and the person is already highly willing to buy the product.

Accordingly, the present invention works particularly effectively on (i) a person who is interested in the product but does not particularly have an intention of buying the product, (ii) a person who is not certain whether to buy the product or not, or (ii) a person who is not in a hurry.

Therefore, limiting a target on the basis of a moving speed has great significance and reason.

<Odor Release Process Carried Out by Odor Release System>

Next, the following description will discuss an odor release process carried out by the odor release system in accordance with the present embodiment.

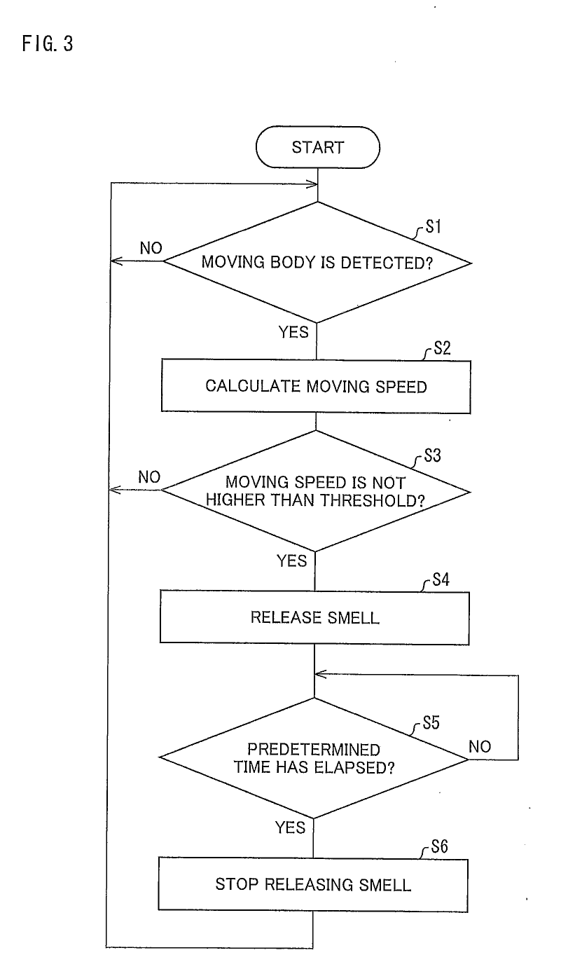

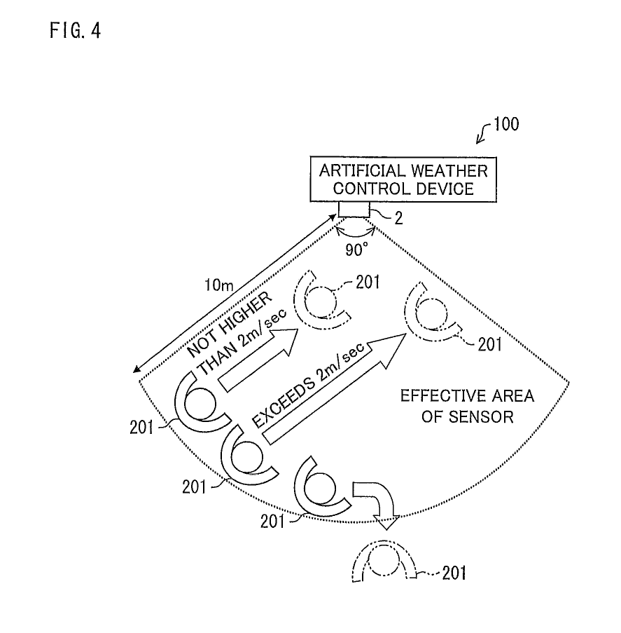

FIG. 3 is a flow chart showing a flow of an odor release process carried out by the odor release system in accordance with the present embodiment. FIG. 4 is a view illustrating how the moving body detecting section 2 detects the moving body 201.

In FIG. 4, the area within the dotted line is an example of an effective detection area of the moving body detecting section 2 in a case where the moving body detecting section 2 is a Doppler sensor. FIG. 4 shows an example in which the moving body detecting section 2 has an effective detection area within a 90° arc of radius 10 m in front of the Doppler sensor. Note, however, that the effective detection area can be changed in various ways and is not limited to the area as described above.

Initially, when the moving body detecting section 2 detects that the moving body 201 has come close to the artificial weather control device 100 (main body 1 of the artificial weather control device) (Step S1), the moving speed calculating section 31 calculates, on the basis of a signal supplied from the moving body detecting section 2, a moving speed of the moving body 201 approaching the artificial weather control device 100 (Step S2).

Next, the odor release control section 32 determines whether or not the moving speed of the moving body 201 calculated by the moving speed calculating section 31 is not higher than a threshold (Step S3). Here, the moving speed threshold is 2 m/sec. In a case where the odor release control section 32 determines that the moving speed of the moving body 201 calculated by the moving speed calculating section 31 is not higher than 2 m/sec as shown in FIG. 4, the odor release control section 32 considers that the moving body 201 is a person to whom the odor is to be released (i.e., a person who belongs to the first group (a “person who is interested” or a “person who is not in a hurry”)). The odor release control section 32 then (i) transmits, to the opening and closing mechanism 44, a signal for causing the lid 42 for the odor release port 41 to open and (ii) transmits, to the motor 45, a signal for causing the fan 43 to rotate. A t the same time, the odor release control section 32 transmits, to the measuring section 33, a signal for starting measurement of time.

This causes the lid 42 to open and the fan 43 to rotate, so that the odor of the odor source 110 is released from the odor release port 41 to the outside (Step S4).

When the time measured by the measuring section 33 reaches a preset time (odor release time (e.g. 10 seconds)) (Step S5), the odor release control section 32 (i) transmits, to the motor 45, a signal for causing the fan 43 to stop, and (ii) transmits, to the opening and closing mechanism 44, a signal for causing the lid 42 to close.

This causes the fan 43 to stop and the lid 42 to close, so that the release of the odor from the odor release port 41 is stopped (Step S6).

On the other hand, in a case where the odor release control section 32 determines in Step S3 that the moving speed of the moving body 201 calculated by the moving speed calculating section 31 is higher than 2 m/sec as shown in FIG. 4, the odor release control section 32 considers that the moving body 201 is not a person to whom the odor is to be released (i.e., a person who belongs to the second group). Accordingly, the odor of the odor source 110 is not released to the outside, and Step S1 for detecting a moving body is carried out again.

Note that in a case where no moving body 201 that approaches the artificial weather control device 100 is detected in Step S1 as indicated by the bent arrow in FIG. 4, Step S2 is not carried out, and moving body detection at Step S1 is carried out again.

As described above, according to the present embodiment, the odor is released so as to attract more customers and encourage the customers to make a purchase. In addition, the odor is released only to a person who has a relatively low moving speed and is therefore considered to be interested or not in a hurry. This allows a reduction in consumption of the active ingredient, such as CO₂, for the plant cultivation in the plant cultivation chamber. Further, releasing the odor to a limited target in this manner makes it possible to maintain (i) the temperature and humidity in the plant cultivation chamber and (ii) the concentration of the active ingredient for plant cultivation in the plant cultivation chamber. Thus, the environment for the cultivation of the plant can be kept in a good condition. In addition, it becomes easier to maintain and control (i) the temperature and humidity in the plant cultivation chamber and (ii) the concentration of the active ingredient for the plant cultivation in the plant cultivation chamber.

Note that although the description above is given on the assumption that the moving speed threshold (walking speed threshold) is 2 m/sec, the moving speed threshold can be set to any speed, as mentioned above.

Also note that although the description above is given on the assumption that the odor release time (time measured by the measuring section 33) is 10 seconds, the odor release time can also be set to any time.

<Modified Example>

The description above discussed the present embodiment by giving an example in which (i) the moving body detecting section 2 is a Doppler sensor and (ii) a person, such as a pedestrian, who approaches the main body 1 of the artificial weather control device is detected based on a moving speed of a moving body 201 detected by means of the Doppler sensor.

Note, however, that the present embodiment is not limited to this. The present embodiment can employ a configuration in which (i) a human body sensor (human sensor) which employs a Doppler sensor is used as the moving body detecting section 2 so as to detect a person approaching the main body 1 of the artificial weather control device to be a moving body 201 which approaches the main body 1 of the artificial weather control device, and (ii) on the basis of a moving speed of the person, the person who approaches the main body 1 of the artificial weather control device is classified into the group (1) or the group (2), as described above.

Note that data communications between devices (sections) in the odor release system can be wired communications or wireless communications.

In the present embodiment, the electronic device including the odor release system in accordance with the present invention is exemplified as the artificial weather control device. Note, however, that the present embodiment is not limited to this.

The odor release system can be incorporated in various electronic devices or various articles both of which are aimed to release an odor of an odor source to a limited target.

That is, although, in the present embodiment, the artificial weather control device main body, which is used for cultivating a plant is used as the housing which houses strawberries as a plant that serves as an odor source, the housing can be a refrigerating storage in which strawberries that have been already harvested are stored as an odor source. In this case, by releasing the odor of the odor source to a limited target in the outside of the house, it is possible to (i) attract more customers and (ii) reduce a cost of cooling the refrigerating storage.

Further, in a case where (i) the product to be sold is, for example, grilled chicken or grilled eel, which are food products that stimulate the sense of smell but are difficult to sell through demonstration sales in which smoke is utilized, and (ii) the food product is sold at, for example, an indoor food products section or the like at a super market or the like, the food product can be sold, not by carrying out a demonstration sale, but by releasing an odor of the food product from a housing, within which an odor ingredient of the food product is confined as an odor source, to the outside of the housing by use of the odor release system.

In this case, it is possible to not only attract more customers by means of the odor, but also reduce costs by reducing consumption of the odor ingredient. The consumption of the odor is reduced by limiting a person to whom the odor is to be released, instead of releasing the odor unconditionally every time a person approaches.

Similarly, by (i) changing the odor ingredient, which serves as an odor source and is to be confined within a housing, to an odor ingredient of an odor suitable for a product to be sold, a product to be handled, or the like (such as an aromatic ingredient used for aroma therapy or in perfumes) and (ii) installing the housing, in which such an odor ingredient is confined, outside a shop or in a shop window or the like. This allows the odor of the product to be smelled by a pedestrian even in a state where the shop is closed up. On the other hand, by releasing no odor to a person who passes by running or a person who passes by on a bicycle, a car, or the like, it is possible to reduce consumption of the odor ingredient.

The description above discussed the present embodiment by giving an example in which (i) the object to which the odor is released is a “person” and (ii) an “odor” (fragrance) is released as the odor of the odor source 110. Note, however, that the present embodiment is not limited to this.

For example, an animal which tries to intrude into or come close to a vegetable garden, a facility in which a bird or the like is raised, a flower garden, a garage, a food storage, or the like tends to have a low moving speed since the animal watches the situation around the animal or searches for a route via which to intrude the vegetable garden or the like. As such, by taking advantage of such a habit and installing, on a fence or an enclosure, (i) a housing in which an odor disliked by the animal is confined and (ii) the odor release system in accordance with the present embodiment, it is possible to prevent or reduce various damages caused by the animal.

That is, the odor of the odor source can be a bad smell, instead of a good smell.

<Program and Computer-Readable Recording Medium>

Each means (block) of the control section 3 (control device) can be configured as a hardware logic or (ii) realized by means of software by use of a CPU (Central Processing Unit) or an MPU (Micro Processing Unit). That is, each means of the control section 3 can be executed by means of software in such a manner that a program is used to cause a computer to function as the means. Each step of the odor release process (odor release control method) carried out by the odor release system can be executed by means of software by use of a program so as to cause a computer to execute the step.

That is, the control section 3 includes a CPU or an MPU for executing commands of a program for implementing each function (step), a ROM (Read Only Memory) in which the program is stored, a RAM (Random Access Memory) on which the program is loaded so as to be executed, a storage device (recording medium), such as a memory, in which the program and various data are stored, and the like.

The object of the present invention can be achieved also by (i) loading, to each section of the control section 3, the recording medium, in which program code (an executable program, an intermediate code program, and a source program) of the control program (software for implementing the functions (steps) of the each section (means) of the control section 3 is recorded so as to be read out by a computer and (ii) causing the computer to or a CPU or an MPU) to read out and execute the program code recorded in the recording medium.

Note that the recording medium via which the program code is supplied the control section 3 is not limited to any particular structure or any particular. That is, example, a tape such as a magnetic tape or a cassette tape, a disk including (i) a magnetic disk such as a floppy® disk or a hard disk and (ii) an optical disc such as a CD-ROM, an MO, an MD, a DVD, or a CD-R, a card such as an IC card (including a memory card) or an optical card, a semiconductor memory such as a mask ROM, an EPROM, an EEPROM, or a flash ROM, or the like can be used as the recording medium.

The object of the present invention can be achieved by arranging the control section 3 to be connectable to a communications network so that the program code may be delivered over the communications network. The communications network is not limited to any particular type or in any particular manner as long as the program code can be delivered to the control section 3. The communications network may be, for example, the Internet, an intranet, extranet, LAN, ISDN, VAN, CATV communications network, virtual dedicated network (virtual private network), telephone line network, mobile communications network, or satellite communications network.

The transfer medium which makes up the communications network is not limited to any particular arrangement or type provided that the transfer medium is a given medium that can transfer the program code. The transfer medium may be, for example, wired line, such as IEEE 1394, USB (Universal Serial Bus), electric power line, cable TV line, telephone line, or ADSL (Asymmetric Digital Subscriber Line) line; or wireless, such as infrared radiation (IrDA, remote control), Bluetooth (Registered Trademark), 802.11 wireless, HDR, mobile telephone network, satellite line, or terrestrial digital network. The present invention encompasses a form of a computer data signal embedded into a carrier wave, in which form the program code is realized by electronic transmission.

### Embodiment 2

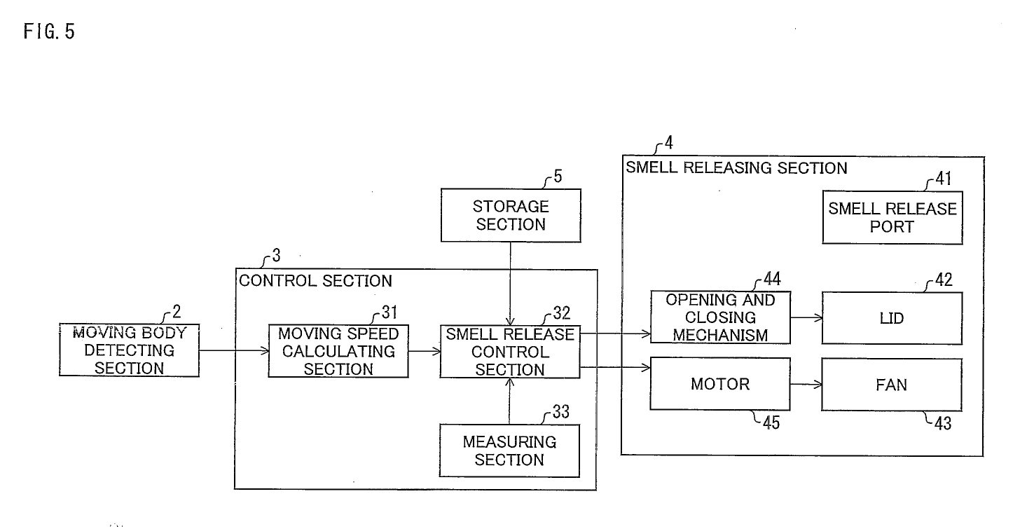

The following description will discuss, with reference to FIG. 5, another embodiment of the present invention.

Note that the present embodiment is discussed in terms of a difference between the present embodiment and Embodiment 1. The same reference signs will be given to components each having the same function as a component illustrated in the figures of Embodiment 1, and descriptions on such a component will be omitted. In addition, descriptions on a step of the same process as that of Embodiment 1 will be omitted.

In Embodiment 1, the description discussed a case in which, in the flow shown in FIG. 3, the odor release control section 32 causes release of an odor from the odor releasing section 4 to be stopped when time measured by the measuring section 33 reaches a preset time.

Note, however, that the preset time (odor release time) does not necessarily have to be fixed in the flow shown in FIG. 3.

Comparison of moving speeds between moving bodies 201 (persons), which (who) are determined to be a person to whom an odor is to be released shows that a person having a relatively low moving speed smells an odor for a shorter period of time than a person having a relatively high moving speed smells the same odor, though the period time varies depending on the effective detection area of the moving body detecting section 2.

However, it is not desirable, in terms of maintaining and controlling the environment for the cultivation of the plant, to set the odor release time relatively long on the basis of the person who has a relatively low moving speed and with respect to whom an odor is to be detected and moving speed.

In view of this, in the present embodiment, the following description will describe an example in which the odor release time is changed in accordance with the moving speed of the moving body 201 calculated by the moving speed calculating section 31.

<Configuration of Odor Release System>

First, the following description will discuss a configuration of an odor release system in accordance with the present embodiment.

FIG. 5 is a block diagram illustrating a configuration of the odor release system in accordance with the present embodiment.

As illustrated in FIG. 5, the odor release system in accordance with the present embodiment further includes, in addition to the devices (sections) illustrated in FIG. 1, a storage section 5 which serves as a storage device.

In the storage section 5, a LUT (Look-up Table, conversion table) for changing the odor release time in accordance with a moving speed of the moving body 201 is stored.

The odor release time, that is, a time period from a point when release of the odor from the odor releasing section 4 is started to a point when the release is stopped is set to be longer, the lower the moving speed of the moving body 201 the moving speed calculating section 31.

As to a moving speed (i.e., a moving speed that is not included in the LUT) of the moving body 201 which moving speed is between moving speeds that are associated with respective odor release times in the LUT, an odor release time with respect to the moving speed can be determined by means of interpolation operation by use of odor release times that are associated with the moving speeds in the LUT. Alternatively, a certain odor release time can be associated with each of moving speeds which are within a certain range.

An EEPROM, which can hold data even after being switched off and is a (i) magnetic disk device such as an HDD or (ii) a semiconductor memory is suitably used as the storage section 5.

<Process of Odor Release Carried Out by Odor Release System>

Next, the following description will discuss a process of odor release carried out by t he odor release system in accordance with the present embodiment.

A flow of a process of odor release carried out by the odor release system in the present embodiment is basically the same as the flow as shown in FIG. 3 in Embodiment 1.

In the present embodiment, at Step S3 in the flow shown in FIG. 3, the odor release control section 32 (i) determines whether or not the moving speed of the moving body 201 calculated by the moving speed calculating section 31 is not higher than the threshold and (ii) determines, with reference to the LUT stored in the storage section 5, an odor release time that is associated with the moving speed of the moving body 201 calculated by the moving speed calculating section 31.

Then at Step S5, when the time measured by the measuring section 33 reaches the preset time which has been preset on the basis of the moving speed (Step S5), the odor release control section 32 (i) transmits, to the motor 45, a signal for causing the fan 43 to stop and (ii) transmits, to the opening and closing mechanism 44, a signal for causing the lid 42 to close.

Thus, in the present embodiment, when the odor release control section 32 causes the release of the odor from the odor release port 41 to stop on the basis of a result of measurement carried out by the measuring section 33, the time period from the point when the release of the odor from the odor release port 41 is started to the point when the release is stopped is set to be longer, the lower the moving speed of the moving body 201 calculated by the moving speed calculating section 31 is.

This allows the odor release time to be changed appropriately in accordance with the moving speed of the moving body 201. As such, a person who has a relatively low moving speed and to whom the odor is to be released can be sufficiently given as much olfactory stimulation as is given to a person who has a relatively high moving speed and to whom the odor is to be released. In addition, it is unnecessary to set the odor release time on the basis of the person who has the relatively low moving speed and to whom the odor is to be released. This makes it possible to give enough olfactory stimulation while (i) achieving a reduction in consumption of an active ingredient, such as CO₂, for the plant cultivation and (ii) protecting an environment in the plant cultivation chamber.

### Embodiment 3

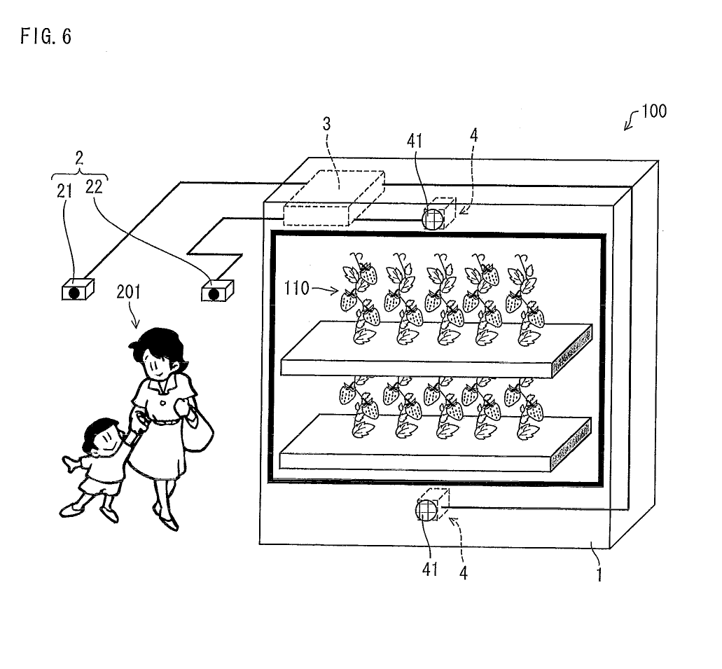

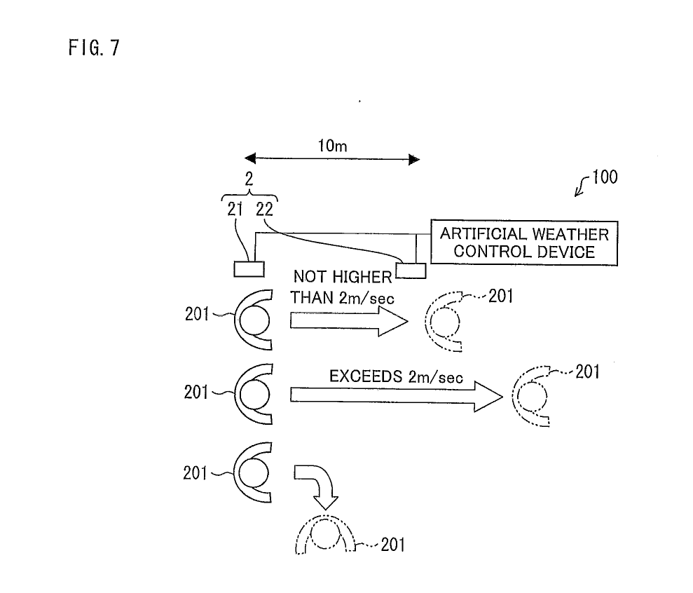

The following description will discuss, with reference to FIGS. 6 and 7, another embodiment of the present invention.

Note that the present embodiment is discussed in terms of a difference between the present embodiment and Embodiment 1. The same reference signs will be given to components each having the same function as a component illustrated in the figures of Embodiment 1, and descriptions on such a component will be omitted. In addition, descriptions on a step of the same process as that of Embodiment 1 will be omitted.

Embodiment 1 was described based on an example in which the moving body detecting section 2 was a Doppler sensor. Note, however, that the sensor used as the moving body detecting section 2 is not limited to any specific one, as long as the sensor is capable of detecting the moving body 201. In addition, the moving body detecting section 2 can be constituted by a combination of a plurality of sensors or a combination of a plurality of types of sensors.

Further, although Embodiment 1 was described based on an example in which the moving body detecting section 2 (Doppler sensor) was mounted to the main body 1 of the artificial weather control device, the present invention is not limited to this. The moving body detecting section 2 can be detached from the main body 1 of the artificial weather control device and installed in any place, depending on an environment in which the main body 1 of the artificial weather control device is installed (e.g., a situation of a passage or a building). Also in this case, data communications between the devices (sections) in the odor release system can be wired communications or wireless communications.

<Configuration of Moving Body Detecting Section>

The following description will discuss a configuration of a moving body detecting section 2 in an odor release system in accordance with the present embodiment.

FIG. 6 is a schematic view illustrating an outer appearance of an artificial weather control device 100 in accordance with the present embodiment. FIG. 7 is a view illustrating how a moving body detecting section 2 illustrated in FIG. 6 detects a moving body.

As illustrated in FIG. 6, the artificial weather control device 100 in accordance with the present embodiment includes, as the moving body detecting section 2, two sensors 21 and 22 which are spaced apart from each other by a fixed distance.

Examples of each of the sensors 21 and 22 encompass a human body sensor (human sensor) or the like for detecting a presence of a person by means of infrared rays, ultrasonic waves, visible rays, or the like, but not necessarily limited to this.

Passages in an exhibition hall or the like are often one-way passages. As such, in this case, arranging the moving body detecting section 2 in front of a place where the artificial weather control device 100 is installed as illustrated in FIGS. 6 and 7 allows detecting a moving body 201 that approaches the artificial weather control device 100.

In the present embodiment, the sensors 21 and 22 are spaced apart from each other by a fixed distance (e.g., 10 m) as illustrated in FIG. 7. The moving speed calculating section 31 calculates a moving speed of the moving body 201 on the basis of time period from a point when the moving body 201 passes by one of the sensors 21 and 22 to a point when the moving body 201 passes by the other of the sensors 21 and 22.

<Process of Odor Release Carried Out By Odor Release System>

Next, the following description will discuss a process of odor release carried out b y the odor release system in accordance with the present embodiment.

A flow of the process of odor release carried out by the odor release system in the present embodiment is basically the same as the flow as shown in FIG. 3 in Embodiment 1.

In the present embodiment, when the sensors 21 and 22 detect that a moving body 201 has come close to the artificial weather control device 100 (main body 1 of the artificial weather control device) at Step S1 in the flow shown in FIG. 3, the moving speed calculating section 31 calculates at Step S2 a moving speed of the moving body 201, which approaches the artificial weather control device 100, on the basis of signals supplied from the respective sensors 21 and 22.

As described above, the moving speed of the moving body 201 can be found on the basis of a difference between (i) a point in time when the moving body 201 is detected by one of the sensors 21 and 22, which are spaced apart from each other by the fixed distance and (ii) a point in time when the moving body 201 is detected by the other of the sensors 21 and 22.

In a case where, at Step S1, the sensor 22 detects no moving body 201 that approaches the artificial weather control device 100 as indicated by the bent arrow in FIG. 7, Step S2 is not carried out and moving body detection at Step S1 is carried out again.

As described above, the moving body detecting section 2 can be a sensor other than the Doppler sensor. In addition, the moving body detecting section 2 can be detached from the main body 1 of the artificial weather control device so as to be installed in any place.

The sensor to be used as the moving body detecting section 2 can be appropriately changed depending on an environment in which the housing is installed, costs, or the like.

### Embodiment 4

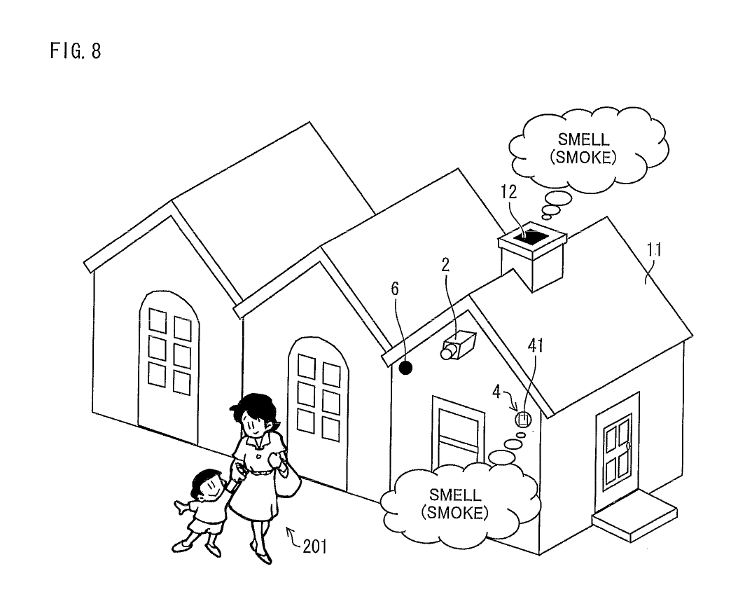

The following description will discuss, with reference to FIGS. 8 through 10, another embodiment of the present invention.

Note that the present embodiment is discussed in terms of a difference between the present embodiment and Embodiment 1. The same reference signs will be given to components each having the same function as a component illustrated in the figures of Embodiment 1, and descriptions on such a component will be omitted.

The present embodiment will be described based on an example in which an odor release system in accordance with the present embodiment is attached to a shop.

FIG. 8 is a schematic view illustrating an outer appearance of a shop 11 to which the odor release system in accordance with the present embodiment is attached.

In the present embodiment, the shop 11 functions as a housing which contains an odor source (not shown).

Although the shop 11 i s not limited to any specific one, the odor release system in accordance with the present embodiment is particularly effective for a shop that (i) can attract more customers by releasing an odor of an odor source to the outside of the shop but (ii) at the same time has a problem of causing harm due to smoke, in which form the odor is released to the outside of the shop. Examples of such a shop include an eel restaurant and a skewered grilled chicken restaurant.

In order for such a shop 11 to prevent causing harm to residents around the shop 11 due to smoke, it is necessary that the odor (smoke) from the odor source be released through an exhaust port 12 that is located away from people on a street.

In view of this, in the present embodiment, the following description will discuss a case as illustrated in FIG. 8 in which (i) normal exhaust, i.e., release of an odor (smoke) from an odor source in a normal state is not carried out through the odor release port 41 but carried out only through the exhaust port 12, such as a chimney, which is located away from the street, and (ii) in a case where a person to whom the odor is to be released approaches the shop 11, the odor is released also through the odor release port 41.

<Configuration of Odor Release System>

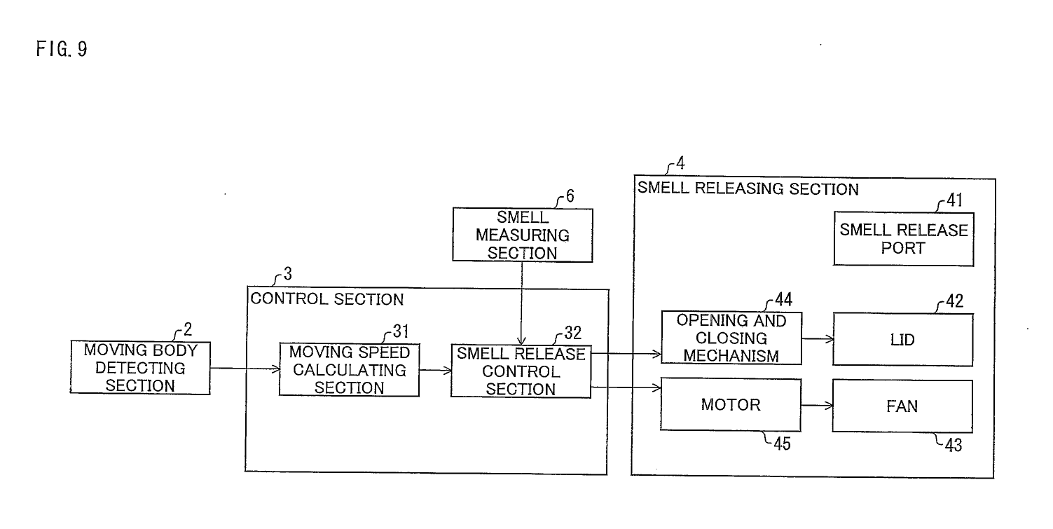

FIG. 9 is a block diagram illustrating a configuration of the odor release system in accordance with the present embodiment.

As illustrated in FIG. 9, the odor release system in accordance with the present embodiment includes (i) a moving body detecting section 2 which serves as the moving body detecting device, (ii) a control section 3 which serves as the control device, (iii) an odor releasing section 4 which serves as the odor detecting device, and (iv) an odor measuring section 6 which serves as an odor measuring device.

<Configurations of Moving Body Detecting Section 2 and Odor Releasing Section 4>

Each of the moving body detecting section 2 and the odor releasing section 4 has the same configuration as that as described in Embodiment 1, except that the moving body detecting section 2 and the odor releasing section 4 are attached to the shop 11 serving as the housing. As such, descriptions on the configurations will be omitted.

Like Embodiment 1, the present embodiment employs a configuration in which (i) a Doppler sensor is used as the moving body detecting section 2, and (ii) a person who approaches the main body 1 of the artificial weather control device is detected on the basis of a moving speed of the moving body 201 detected by the Doppler sensor. Note, however, that the present embodiment is not limited to this.

As in the present embodiment, in a case where the shop 11 is provided with the moving body detecting section and the odor releasing section 4, the moving body detecting section 2 and the odor releasing section 4 are provided so as to face the street.

<Configuration of Odor Measuring Section 6>

The odor measuring section 6 measures an intensity of an odor around the shop 11 which odor has been released from the odor releasing section 4 to the outside of the shop 11.

The odor measuring section 6 can be a general odor measuring instrument such as an odor sensor. Note that the odor measuring instrument is not limited to any particular type, and can be various types of known sensors that measure an intensity of an odor.

<Configuration of Control Section 3>

As illustrated in FIG. 9, the control section 3 includes a moving speed calculating section 31 and an odor release control section 32.

As in Embodiment 1, in the present embodiment, calculation of a moving speed of the moving body 201 carried out by the control section 3 and release of an odor carried out by the odor releasing section 4 are triggered by a detection signal received from the moving body detecting section 2.

On the other hand, the release of the odor carried out by the odor releasing section 4 is stopped on the basis of a result measured by the odor measuring section 6, unlike in Embodiment 1 in which the release of the odor is stopped in accordance with the odor release time measured by the measuring section 33.

The odor release control section 32 monitors a signal which is indicative of an intensity of the odor and is transmitted from the odor measuring section 6.

When the moving body 201 (person to whom the odor is to be released) to which the odor is to be released approaches the shop 11 which serves as the housing, the odor release control section 32 causes the odor releasing section 4 to release the odor. When a value measured by the odor measuring section 6 is higher than a preset threshold which is indicative of an intensity of an odor, the odor release control section 32 causes the odor releasing section 4 to stop releasing the odor through the odor release port 41.

<Process of Odor Release Carried Out by Odor Release System>

Next, the following description will discuss a process of odor release carried out by t he odor release system in accordance with the present embodiment.

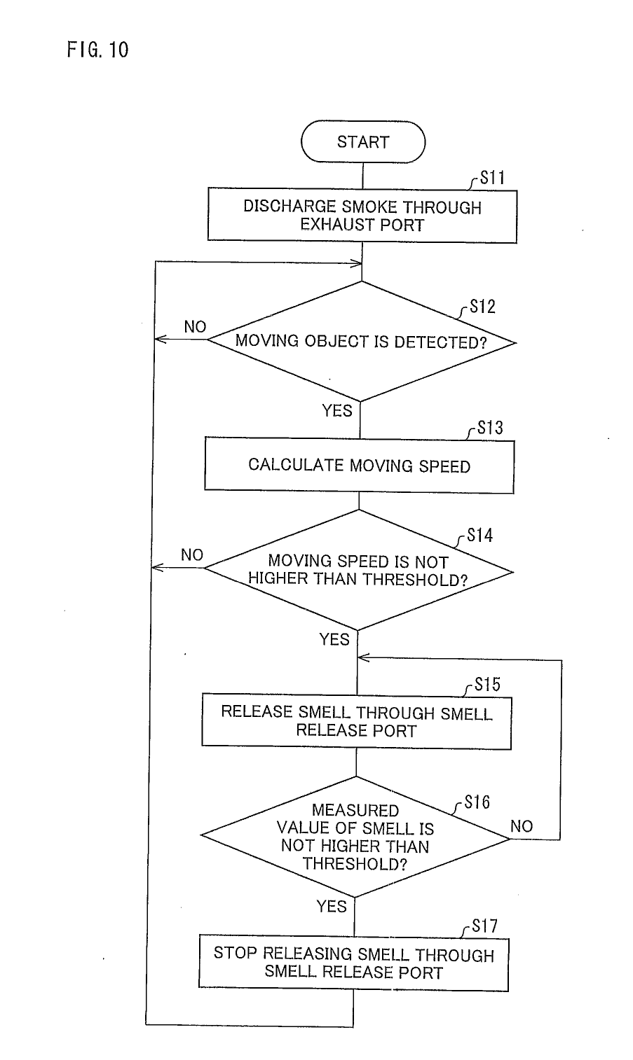

FIG. 10 is a flow chart showing a flow of a process of odor release carried out by the odor release system in accordance with the present embodiment.

First, smoke is exhausted through the exhaust port 12 of the shop 11 (Step S11). In this state, when the moving body detecting section 2 detects that the moving body 201 has come close to the shop 11 (Step S12), the moving speed calculating section 31 calculates, on the basis of a signal supplied from the moving body detecting section 2, a moving speed of the moving body 201 approaching the shop 11 (Step S13).

Next, the odor release control section 32 determines whether or not the moving speed of the moving body 201 calculated by the moving speed calculating section 31 is not higher than the threshold (Step S14). Here, the moving speed threshold is 2 m/sec. In a case where the odor release control section 32 determines that the moving speed of the moving body 201 calculated by the moving speed calculating section 31 is not higher than 2 m/sec as shown in FIG. 4, the odor release control section 32 considers that the moving body 201 is a person to whom the odor is to be released, i.e., a person who belongs to the first group (“person who is interested” or “person who is not in a hurry”). Then, the odor release control section 32 (i) transmits, to the opening and closing mechanism 44, a signal for causing the lid 42 provided to the odor release port 41 to be opened, and (ii) transmits, to the motor 45, a signal for causing the fan 43 to rotate. At the same time, the odor release control section 32 transmits, to the odor measuring section 6, a signal for starting measurement of the odor.

This causes the lid 42 to open and the fan 43 to rotate, so that the odor of the odor source 110 is released to the outside through the odor release port 41 (Step S15).

The odor release control section 32 determines whether or not a value measured by the odor measuring section 6 is not higher than the threshold (Step S16). Here, (i) the threshold (odor index in the odor measuring instrument) of a measured value of odor is 500, and (ii) the higher the measured value is, the more intense the odor is. In a case where the odor release control section 32 determines that the value measured by the odor measuring section 6 is not higher than 500, the odor release control section 32 proceeds to Step S15 to cause the odor releasing section 4 to release the odor through the odor release port 41.

On the other hand, in a case where the value measured by the odor measuring section 6 is higher than 500 at Step S16, the odor release control section 32 (i) transmits, to the motor 45, a signal for causing the fan 43 to stop and (ii) transmits, to the opening and closing mechanism 44, a signal for causing the lid 42 to close. This causes the fan 43 to stop and the lid 42 to close, so that the release of the odor through the odor release port 41 is stopped (Step S17).

On the other hand, in a case where the odor release control section 32 determines at Step S14 that the moving speed of the moving body 201 calculated by the moving speed calculating section 31 is higher than 2 m/sec as shown in FIG. 4, the odor release control section 32 considers that the moving body 201 is not a person to whom the odor is to be released (i.e., the moving body 201 belongs to the second group). Accordingly, the odor in the shop 11 is not released to the outside through the odor release port 41, and Step S12 for detecting a moving body is carried out again.

In a case where no moving body 201 that approaches the shop 11 is detected at Step S12, Step S13 is not carried out and moving body detection at Step S13 is carried out again.

As described above, according to the present embodiment, it is possible to not only attract more customers by releasing an odor, but also prevent giving, to the residents around the shop 11, harm caused by smoke accompanying the odor released through the odor release port 41 which is provided so as to face the street. This is made possible because (i) the odor accompanied by the smoke is prevented from spreading around the shop 11 and (ii) the smoke is prevented from pervading the air around the shop 11.

As in Embodiment 1, the moving speed threshold (walking speed threshold) in the present embodiment is set to 2 m/sec. Note, however, that the moving speed threshold can be set to any speed.

In addition, the threshold of the value measured by the odor measuring section 6 can also be set to any value. In the description above, the value measured by the odor measuring section 6 is an odor index in the odor measuring instrument. Note, however, that the present embodiment is not limited to this. The value measured by the odor measuring section 6 can be set to various values in accordance with a type of the odor measuring instrument that is used as the odor measuring section 6. Examples of the various values include (i) a concentration of the odor and (ii) a voltage indicative of an intensity of the odor.

<Modified Example>

The present embodiment was described on the basis of an example in which the moving body detecting section 2 was a Doppler sensor as described above. Note, however, that the moving body detecting section 2 is not limited to any specific one, as long as it is capable of detecting the moving body 201 that approaches the shop 11. the moving body detecting section 2 be constituted by a plurality of sensors or a plurality of types of sensors. As described above, the sensor to be used as the moving body detecting section 2 can be changed appropriately depending on (i) an environment in which the housing is installed, (ii) costs, and (iii) the like.

Note that the moving body detecting section 2 can be, for example, a video camera such as a surveillance camera. In this case, by carrying out, for example, an image processing by means of software, it is possible to calculate a moving speed of the moving body 201 that approaches the shop 11.

Further, the present embodiment was discussed based on an example in which an odor control system was attached to the shop 11 that needed to take measures against harm caused by smoke. Note, however, that the present embodiment is not limited to this.

For example, an odor which is pleasant when the odor is not very strong may become unpleasant when the odor is too strong. A typical example of such an odor is an odor of undiluted perfume oil. In addition, time that is taken until an odor is diffused via an odor ingredient varies. As such, by causing release of an odor to be stopped depending on an intensity of the odor, it is possible to (i) reduce consumption of an odor ingredient itself in a case where the odor ingredient is expensive and (ii) reduce a cost of maintenance and control of an environment in which an odor source is stored or an environment in which a plant is cultivated, in a case where such maintenance and control is necessary.

### Embodiment 5

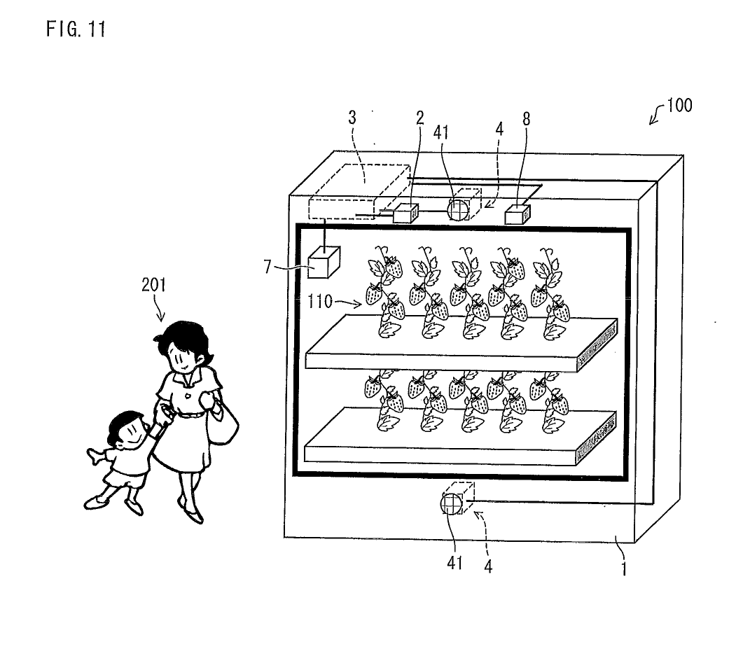

The following description will discuss, with reference to FIGS. 11 through 13, another embodiment of the present invention.

Note that the present embodiment is discussed in terms of a difference between the present embodiment and Embodiment 1. The same reference signs will be given to components each having the same function as a component illustrated in the figures of Embodiment 1, and descriptions on such a component will be omitted.

Also in the present embodiment, an artificial weather control device is discussed as an example of an electronic device having an odor release system in accordance with the present invention.

<General Configuration of Artificial Weather Control Device>

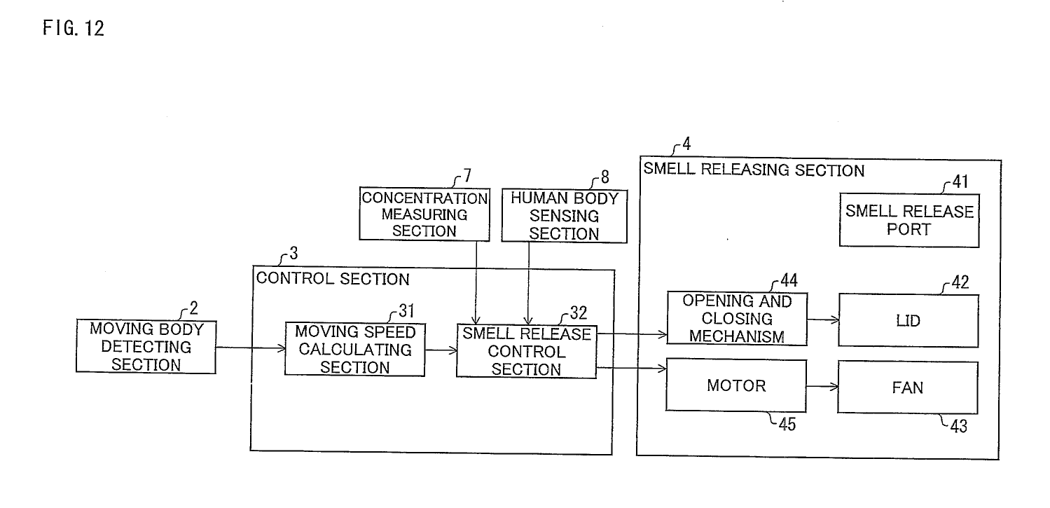

FIG. 11 is a schematic view illustrating an outer appearance of an artificial weather control device 100 in accordance with the present embodiment. FIG. 12 is a block diagram illustrating a configuration of an odor release system in accordance with the present embodiment.

As illustrated in FIG. 12, the odor release system in accordance with the present embodiment includes (i) a moving body detecting section 2 which serves as the moving body detecting device, (ii) a control section 3 which serves as the control device, (iii) an odor releasing section which serves as the odor detecting device, (iv) a concentration measuring section 7 which serves as a concentration measuring device, and (v) a human body sensing section 8 which serves as a human body detecting device.

As illustrated in FIG. 11, the artificial weather control device 100 in accordance with the present embodiment has a configuration in which the devices (sections) the odor release system in accordance with the present embodiment as described above are attached to a main body 1 of an artificial weather control device (housing), which main body is an electronic device main body in accordance with the present embodiment.

The following description will discuss a configuration of each of the sections (devices) of the artificial weather control device 100.

<Configurations of Main Body 1 of Artificial Weather Control Device, Moving Body Detecting Section 2, and Odor Releasing Section 4>

Each of the main body 1 of the artificial weather control device, the moving body detecting section 2, and the odor releasing section 4 has the same configuration of as that as described in Embodiment 1. As such, descriptions on the configurations will be omitted.

<Configuration of Concentration Measuring Section 7>

The concentration measuring section 7 measures a concentration of a gas (gaseous component) required for cultivating a plant in the main body 1 of the artificial weather control device, specifically in the plant cultivation chamber of the main body 1 of the artificial weather control device.

Here, the gas required for cultivating the plant in the plant cultivation chamber is, for example, CO₂, O₂, water vapor, or the like as described above. These gases can be supplied individually or supplied together as a mixed gas.

The concentration measuring instrument used as the concentration measuring section 7 is not limited to any specific one, as long as the concentration measuring instrument is capable of measuring a concentration of a gas to be measured. Note that it is also possible to use an odor sensor as the concentration measuring instrument.

In the present embodiment, the following description will discuss a case in which the concentration measuring section 7 is a CO₂ sensor and measures a CO₂ concentration in the plant cultivation chamber. Note, however, that the present embodiment is not limited to this.

<Configuration of Human Body Sensing Section 8>

The human body sensing section 8 is constituted by a sensor or the like and detects a person in the vicinity of the human body sensing section 8. The sensor can be, for example, the human body sensor (human sensor) as described above. Note, however, that the sensor is not limited to any specific one, as long as it is capable of detecting a person in the vicinity of the human body sensing section 8. The human body sensing section 8 can be constituted by a combination of a plurality of sensors or a combination of a plurality of types of sensors.

<Configuration of Control Section 3>

As illustrated in FIG. 12, the control section 3 includes a moving speed calculating section 31 and an odor release control section 32.

In the present embodiment, the control section 3 (i) calculates a moving speed of the moving body 201 on the basis of a detection signal received from the moving body detecting section 2, and (ii) controls release of an odor from the odor releasing section 4 by using, as controllable factors, the moving speed thus calculated and a result measured by the concentration measuring section 7.

The odor release control section 32 monitors a signal which (i) is transmitted from the concentration measuring section 7 and (ii) is indicative of a concentration of a gaseous component to be measured.

When the moving body 201 (person to whom the odor is to be released) to which the odor is to be released approaches the main body 1 of the artificial weather control device, which main body serves as the housing, the odor release control section 32 causes the odor releasing indicative of the concentration of the gas, which concentration has been measured by the concentration measuring section 7, is higher than a preset threshold and (ii) the moving speed of the moving body 201, which moving speed has been calculated by the moving speed calculating section 31, is not higher than a preset speed.

That is, the odor release control section 32 does not cause the odor releasing section 4 to release the odor in a case where (i) the value indicative of the concentration of the gas measured by the concentration measuring section 7 is not higher than the preset threshold or (ii) the moving speed of the moving body 201 calculated by the moving speed calculating section 31 is higher than the preset speed. When the value indicative of the concentration of the gas measured by the concentration measuring section 7 drops below the preset threshold after the odor releasing section 4 started releasing the odor, the odor release control section 32 causes the release of the odor to stop and does not cause the odor releasing section 4 to release the odor.

Further, after the odor releasing section 4 started releasing the odor, the odor release control section 32 causes the release of the odor to stop (i) when the value indicative of the concentration of the gas measured by the concentration measuring section 7 drops below the preset threshold as described above or (ii) when the odor release control section 32 determines, on the basis of the detection signal received from the human body sensing section 8, that no person is present around the artificial weather control device 100.

<Process of Odor Release Carried Out By Odor Release System>

Next, the following description will discuss a process of odor release carried out by an odor release system in accordance with the present embodiment.

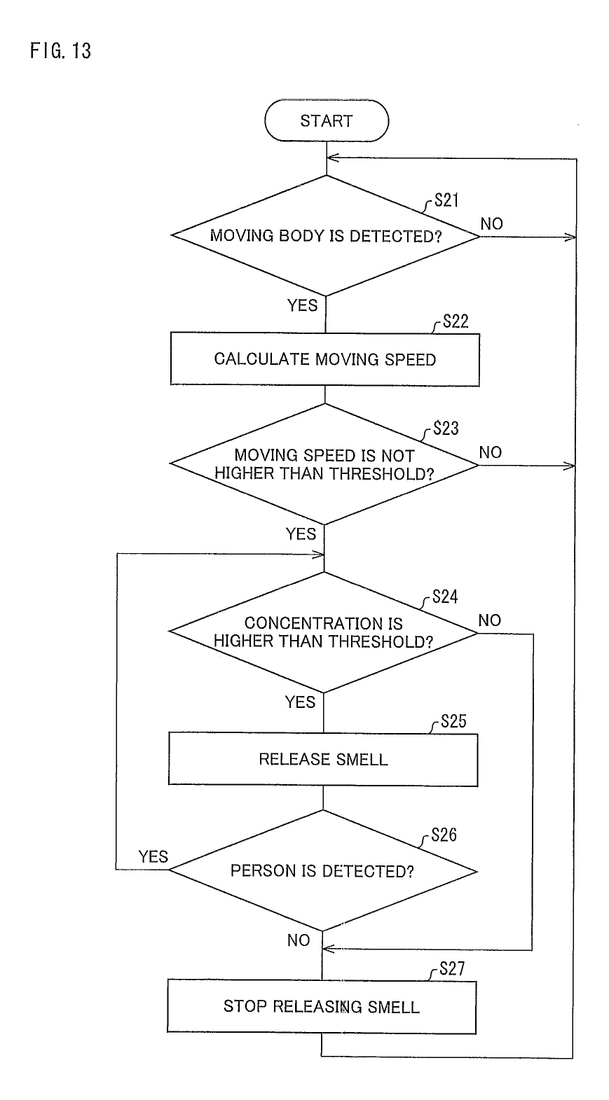

FIG. 13 is a flow chart showing a flow of a process of odor release carried out by the odor release system in accordance with the present embodiment.

First, when the moving body detecting section 2 detects that a moving body 201 has come close to the artificial weather control device 100 (the main body 1 of the artificial weather control device) (Step S21), the moving speed calculating section 31 calculates, on the basis of a signal supplied from the moving body detecting section 2, a moving speed of the moving body 201 approaching the artificial weather control device 100 (Step S22).

Next, the odor release control section 32 determines whether or not the moving speed of the moving body 201 calculated by the moving speed calculating section 31 is not higher than a threshold (Step S23). Here, the moving speed threshold is 2 m/sec. In a case where the odor release control section 32 determines that the moving speed of the moving body 201 calculated by the moving speed calculating section 31 is not higher than 2 m/sec, the odor release control section 32 considers the moving body 201 as a person to whom the odor is to be released, i.e., a person who belongs to the first group (“person who is interested” or “person who is not in a hurry”).

Then, the odor release control section 32 determines whether or not a gas concentration measured by the concentration measuring section 7 is not higher than a threshold (Step S24). Here, the threshold of gas concentration is 800 ppm. In a case where the odor release control section 32 determines that a value measured by the concentration measuring section 7 is higher than 800 ppm, the odor release control section 32 (i) transmits, to the opening and closing mechanism 44, a signal for causing the lid 42, which is provided to the odor release port 41, to open and (ii) transmits, to the motor 45, a signal for causing the fan 43 to rotate.

This causes the lid 42 to open and the fan 43 to rotate, so that the odor of the odor source 110 is released to the outside through the odor release port 41 (Step S25).

Next, the odor release control section 32 determines whether or not the human body sensing section 8 has detected a person within an effective detection area (e.g., an area within 3 m from the artificial weather control device 100) of the human body sensing section 8 (Step S26). At this time, in a case where a person has been detected, the odor release control section 32 returns to Step S24 so as to determine whether or not the gas concentration is higher than the threshold. Note that the concentration measuring section 7 keeps measuring a gas concentration while the odor releasing section 4 releases the odor.

Note that in a case where no person is detected at Step S26, the odor release control section 32 (i) transmits, to the motor 45, a signal for causing the fan 43 to stop and (ii) transmits, to the opening and closing mechanism 44, a signal for causing the lid 42 to close.

In a case where the value measured by the concentration measuring section 7 is not higher than the threshold at Step S24, the odor release control section 32 (i) does not cause the odor releasing section 4 to release the odor or (ii) causes release of the odor to be stopped if the odor is being released. The odor release control section 32 carries out (i) and (ii) even if (a) the moving speed of the moving body 201 is not higher than the threshold or (b) the odor release control section 32 determines that a person who is present around the artificial weather control device 100 has been detected by the human body sensing section 8.

As such, in a case where the value measured by the concentration measuring section 7 is not higher than the threshold at Step S24, the odor release control section 32 (i) transmits, to the motor 45, the signal for causing the fan 43 to stop and (ii) transmits, to the opening and closing mechanism 44, the signal for causing the lid 42 to close.

This causes the fan 43 to stop and the lid 42 to close, so that the odor releasing section 4 is caused to stop releasing the odor through the odor release port 41 (Step S27).

On the other hand, in a case where the odor release control section 32 determines that the moving speed of the moving body 201 calculated by the moving speed calculating section 31 is higher than 2 m/sec at Step S24, the odor release control section 32 considers that the moving body 201 is not a person to whom the odor is to be released (that is, the moving body 201 is a person who belongs to the second group). Accordingly, the odor inside the shop 11 is not released to the outside through the odor release port 41, and Step S1 for detecting a moving body is carried out again.

Note that in a case where no moving body 201 that approaches is detected at Step S21, Step S22 is not carried out and moving body detection at Step S11 is carried out again.

As described above, according to the present embodiment, the odor is released so as to attract more customers and encourage the customers to make a purchase. In addition, the odor is released only to a person who has a relatively low moving speed and is therefore considered to be interested or not in a hurry. This allows a reduction in consumption of the gaseous component (active ingredient for the plant cultivation), such as CO₂, which is necessary for the plant cultivation in the plant cultivation chamber. Further, releasing the odor to a limited target in this manner makes it possible to maintain (i) the temperature and humidity in the plant cultivation chamber and (ii) the concentration of the active ingredient for plant cultivation in the plant cultivation chamber. Thus, the environment for the cultivation of the plant can be kept in a good condition. In addition, it becomes easier to maintain and control (i) the temperature and humidity in the plant cultivation chamber and (ii) the concentration of the active ingredient for the plant cultivation in the plant cultivation chamber.

In terms of comparison between (i) release of the odor and (ii) maintenance of the concentration of the active ingredient for the plant cultivation in the present embodiment, giving priority to the maintenance over the release makes it possible to maintain the concentration of the active ingredient for the plant cultivation at a level higher than the preset threshold. This further facilitates the maintenance and control of (i) the temperature and humidity in the plant cultivation chamber and (ii) the concentration of the active ingredient for the plant cultivation in the plant cultivation chamber.

As in Embodiment 1, the moving speed threshold (walking speed threshold) in the present embodiment was set to 2 m/sec. Note, however, that the moving speed threshold can be set to any speed.

In addition, the threshold of the value measured by the concentration measuring section 7 can be set to any value, and the effective detection area of the human body sensing section 8 can be set in accordance with any value.

<Main Points of Invention>

As described above, an odor release system in accordance with the present invention is an odor release system including: (1) an odor release device provided to a housing that contains an odor source, the odor release device releasing an odor from the housing to an outside of the housing; (2) a moving body detecting device for detecting a moving body that approaches the housing; and (3) a control device including (i) a moving speed calculating section for calculating a moving speed of the moving body on the basis of a detection signal received from the moving body detecting device and (ii) an odor release control section for causing the odor release device to release the odor when the moving speed calculated by the moving speed calculating section is not higher than a preset speed.

An odor release control method for an odor release system in accordance with the present invention is an odor release control method for an odor release system including: (1) an odor release device provided to a housing that contains an odor source, the odor release device releasing an odor from the housing to an outside of the housing; and (2) a moving body detecting device for detecting a moving body that approaches the housing, said odor release control method comprising the steps of: (i) calculating a moving speed of the moving body on the basis of a detection signal indicative of detection of the moving body approaching the housing; and (ii) causing the odor release device to release the odor in a case where the moving speed calculated in the step (i) is not higher than a preset speed.

As described above, the odor release system limits, on the basis of the moving speed of the moving body, a target to which the odor is to be released. Releasing the odor to a limited target in this manner not only provides a direct merit resulting from the odor itself, such as (i) attracting more customers and (ii) encouraging more customers to make a purchase, but also reduces a demerit of releasing the odor, as described above. That is, for example, it is possible to achieve various effects such as (i) reducing a cost of the maintenance and control of the environment inside the housing (e.g. maintenance and control of the temperature and the humidity inside the housing), which cost results from releasing the odor or (ii) prevention or suppression of (a) a reduction in supply of the gaseous component inside the housing, which reduction is caused by consumption of the gaseous component at the time of releasing the odor or (b) harm caused by smoke, in which form the odor is released.

In the odor release system, it is preferable that the odor release device include (i) an odor release port for releasing, to the moving body approaching the housing, the odor generated from the odor source, the odor release port being provided so as to face the outside of the housing and (ii) an opening and closing lid for opening and closing the odor release port; and the odor release control section (i) cause the opening and closing lid to open when the moving speed calculated by the moving speed calculating section is not higher than the preset speed, and (ii) cause the opening and closing lid to close when the moving speed calculated by the moving speed calculating section is higher than the preset speed.

In this manner, by controlling, on the basis of the moving speed of the moving body, the opening and closing lid to open and close, which opening and closing lid opens and closes the odor release port, it is possible to control releasing the odor in accordance with the moving speed of the moving body.

In the odor release system, it is preferable that the odor release device include an air blower for sending air from the odor release port to the outside of the housing, driving of the air blower being controlled by the odor release control section; and only when the moving speed calculated by the moving speed calculating section is not higher than the preset speed, the odor release control section cause (i) the opening and closing lid to open and (ii) the air blower to be driven.

In this manner, by (i) controlling the opening and closing lid to open and close, which opening and closing lid opens and closes the odor release port and (ii) controlling the air blower to be driven, it is possible to (i) control release of the odor in accordance with the moving speed of the moving body and (ii) in releasing the odor, actively outside when the odor is to be released.

It is preferable that the odor release system further include an odor measuring device for measuring an intensity of the odor which has been released by the odor release device to the outside of the housing, the odor release control section causing the odor release device to stop releasing the odor when a value indicative of the intensity measured by the odor measuring device is higher than a preset value.

Causing the release of the odor to be stopped depending on the intensity of the odor in this manner allows consideration for a neighborhood with respect to harm caused by smoke in a case where the odor is accompanied by the smoke. It becomes also possible to (i) reduce consumption of an odor ingredient itself in a case where the odor ingredient is expensive and (ii) reduce a cost of protection of an environment inside the housing in a case where the protection in the environment inside the housing is necessary.

It is preferable that the control device further include a measuring section for measuring time that has elapsed since the odor release device started releasing the odor; and the odor release control section cause the odor release device to stop releasing the odor when the time measured by the measuring section has reached a fixed time.

Causing the odor release device to stop releasing the odor in this manner allows inhibiting wasteful release of the odor in a case where the time measured by the measuring section has reached the fixed time (i.e., preset odor release time). Consequently, the various effects as described above can be provided.

It is preferable that the control device further include a measuring section for measuring time that has elapsed since the odor release device started releasing the odor; the odor release control section cause the odor release device to stop releasing the odor on the basis of a result measured by the measuring section; and the odor release control section set a time period from a point when the odor release device starts releasing the odor to a point when the odor release device stops releasing the odor so that the lower the moving speed calculated by the moving speed calculating section is, the longer the time period is.

This allows the odor release time to be changed appropriately in accordance with the moving speed of the moving body. As such, a moving body which has a relatively low moving speed and to which the odor is to be released can be sufficiently given as much olfactory stimulation as is given to a moving body which has a relatively high moving speed and to which the odor is to be released. In addition, it is unnecessary to set the odor release time on the basis of the moving body which has the relatively low moving speed and to which the odor is to be released. This makes it possible to give enough olfactory stimulation while (i) achieving a reduction in consumption of the gaseous component inside the housing and (ii) protecting the environment inside the housing.

Further, as described above, in order to attain the object, an odor release system in accordance with the present invention is an odor release system including: (1) an odor release device provided to a housing in which a plant serving as an odor source is contained and cultivated, the odor release device releasing an odor from the housing to an outside of the housing; (2) a concentration measuring device for measuring a concentration of a gas that is necessary for cultivating the plant inside the housing; (3) a moving body detecting device for detecting a moving body that approaches the housing; and (4) a control device including (i) a moving speed calculating section for calculating a moving speed of the moving body on the basis of a detection signal received from the moving body detecting section and (ii) an odor release control section for causing the odor release device to release the odor in a case where (a) a value indicative of the concentration measured by the concentration measuring device is higher than a preset value and (b) the moving speed calculated by the moving speed calculating section is not higher than a preset speed.

Further, in order to attain the object, an odor release control method for an odor release system in accordance with the present invention is an odor release control method for an odor release system including: (1) an odor release device provided to a housing in which a plant serving as an odor source is provided and cultivated, the odor release device releasing an odor from the housing to an outside of the housing; (2) a concentration measuring device for measuring a concentration of a gas that is necessary for cultivating the plant inside the housing; and (3) a moving body detecting device for detecting a moving body that approaches the housing, said odor release control method comprising the steps of: (i) calculating a moving speed of the moving body on the basis of a detection signal indicative of detection of the moving body approaching the housing; and (ii) causing the odor release device to release the odor in a case where (a) a value indicative of the concentration of the gas that is necessary for cultivating the plant inside the housing is higher than a preset value and (b) the moving speed calculated in the step (i) is not higher than a preset speed.

As described above, the odor release system limits, on the basis of the moving speed of the moving body, a target to which the odor is to be released. Releasing the odor to a limited target in this manner not only provides a direct merit resulting from the odor itself, such as (i) attracting more customers and (ii) encouraging more customers to make a purchase, but also reduces a demerit of releasing the odor, as described above. That is, for example, it is possible to achieve various effects such as (i) reducing a cost of the maintenance and control of the environment inside the housing (e.g. maintenance and control of the temperature and the humidity inside the housing), which cost results from releasing the odor or (ii) prevention or suppression of a reduction in supply of the gaseous component inside the housing, which reduction is caused by consumption of the gaseous component at the time of releasing the odor.

Further, according to the configurations, in terms of comparison between (i) release of the odor and (ii) maintenance of the concentration of the active ingredient for the plant cultivation in the present embodiment, giving priority to the maintenance over the release makes it possible to maintain the concentration of the active ingredient for the plant cultivation at a level higher than the preset threshold. This further facilitates the maintenance and control of (i) the temperature and humidity in the plant cultivation chamber and (ii) the concentration of the active ingredient for the plant cultivation in the plant cultivation chamber.

An electronic device in accordance with the present invention includes an odor release system in accordance with the present invention. Examples of the electronic device encompass an artificial weather control device.

An article in accordance with the present invention includes an odor release system in accordance with the present invention.

According to these configurations, it is possible to achieve the various effects since the electronic device or the article includes an odor release system in accordance with the present invention.

Note that each step of the odor control methods for the odor release systems can be realized by use of a computer. In this case, it is possible to cause the computer to execute each step of the odor release control methods for the odor release systems in accordance with a program. As such, (i) the program for causing the computer to realize the odor control methods for the odor release systems and (ii) a computer-readable recording medium in which the program is recorded, are also included in the scope of the present invention.

The present invention is not limited to the above-described embodiments but allows various modifications within the scope of the claims. Any embodiment obtained by appropriately combining the technical means disclosed in the different embodiments will also be included in the technical scope of the present invention.

### INDUSTRIAL APPLICABILITY

The present invention can be suitably applied to (i) various devices which sense a moving body and cause an odor to be released or (ii) various articles which sense a moving body and cause an odor to be released.

### Reference Signs List

1: artificial weather control device main body (housing)
2: moving body detecting section (moving body detecting device)
3: control section (control device)
4: odor releasing section (odor release device)
5: storage section (storage device)
6: odor measuring section (odor measuring device)
7: concentration measuring section (concentration measuring device)
8: human body sensing section (human body detecting device)
11: shop (housing)
12: exhaust port
21: sensor (moving body detecting device)
22: sensor (moving body detecting device)
31: moving speed calculating section (moving speed calculating means)
32: odor release control section (odor release controlling means)
33: measuring section (measuring means)
41: odor release port (odor release device)
43: fan (air blower, odor release device)
44: opening and closing mechanism (odor release device)
45: motor (odor release device)
100: artificial weather control device (electronic device)
201: moving body

1. An odor release system comprising:
an odor release device provided to a housing that contains an odor source, the odor release device releasing an odor from the housing to an outside of the housing;
a moving body detecting device for detecting a moving body that approaches the housing; and
a control device including (i) a moving speed calculating section for calculating a moving speed of the moving body on the basis of a detection signal received from the moving body detecting device and (ii) an odor release control section for causing the odor release device to release the odor in a case where the moving speed calculated by the moving speed calculating section is not higher than a preset speed.

2. The odor release system as set forth in claim 1, wherein:
the odor release device includes (i) an odor release port for releasing, to the moving body approaching the housing, the odor generated from the odor source, the odor release port being provided so as to face the outside of the housing and (ii) an opening and closing lid for opening and closing the odor release port; and
the odor release control section (i) causes the opening and closing lid to open in a case where the moving speed calculated by the moving speed calculating section is not higher than the preset speed, and (ii) causes the opening and closing lid to close in a case where the moving speed calculated by the moving speed calculating section is higher than the preset speed.

3. The odor release system as set forth in claim 2, wherein:
the odor release device includes an air blower for sending air from the odor release port to the outside of the housing, driving of the air blower being controlled by the odor release control section; and
only in a case where the moving speed calculated by the moving speed calculating section is not higher than the preset speed, the odor release control section causes (i) the opening and closing lid to open and (ii) the air blower to be driven.

4. An odor release system as set forth in claim 1, further comprising an odor measuring device for measuring an intensity of the odor which has been released by the odor release device to the outside of the housing,
the odor release control section causing the odor release device to stop releasing the odor in a case where a value indicative of the intensity measured by the odor measuring device is higher than a preset value.

5. The odor release system as set forth in claim 1, wherein:
the control device further includes a measuring section for measuring time that has elapsed since the odor release device started releasing the odor; and
the odor release control section causes the odor release device to stop releasing the odor in a case where the time measured by the measuring section has reached a fixed time.

6. The odor release system as set forth in claim 1, wherein:
the control device further includes a measuring section for measuring time that has elapsed since the odor release device started releasing the odor;
the odor release control section causes the odor release device to stop releasing the odor on the basis of a result measured by the measuring section; and
the odor release control section sets a time period from a point when the odor release device starts releasing the odor to a point when the odor release device stops releasing the odor so that the lower the moving speed calculated by the moving speed calculating section is, the longer the time period is.

7. An odor release system comprising:
an odor release device provided to a housing in which a plant serving as an odor source is contained and cultivated, the odor release device releasing an odor from the housing to an outside of the housing;
a concentration measuring device for measuring a concentration of a gas that is necessary for cultivating the plant inside the housing;
a moving body detecting device for detecting a moving body that approaches the housing; and
a control device including (i) a moving speed calculating section for calculating a moving speed of the moving body on the basis of a detection signal received from the moving body detecting section and (ii) an odor release control section for causing the odor release device to release the odor in a case where (a) a value indicative of the concentration measured by the concentration measuring device is higher than a preset value and (b) the moving speed calculated by the moving speed calculating section is not higher than a preset speed.

8. An electronic device including an odor release system recited in claim 1.

9. The electronic device as set forth in claim 8, wherein:
the electronic device is an artificial weather control device.

10. An article comprising an odor release system recited in claim 1.

11. An odor release control method for an odor release system,
said odor release system including:
an odor release device provided to a housing that contains an odor source, the odor release device releasing an odor from the housing to an outside of the housing; and
a moving body detecting device for detecting a moving body that approaches the housing,
said odor release control method comprising the steps of
(i) calculating a moving speed of the moving body on the basis of a detection signal indicative of detection of the moving body approaching the housing; and
(ii) causing the odor release device to release the odor in a case where the moving speed calculated in the step (i) is not higher than a preset speed.

12. (canceled)

13. A program for causing a computer to execute each step recite in claim 11.

14. A computer-readable recording medium in which a program recited in claim 13 is stored.

15. An electronic device including an odor release system recited in claim 7.

16. The electronic device as set forth in claim 15, wherein:
the electronic device is an artificial weather control device.

17. An article comprising an odor release system recited in claim 7.
